(19) United States
(12) Patent Application Publication
(10) Pub. No.: US 2026/0014565 A1
(43) Pub. Date: Jan. 15, 2026

(54) IMPROVEMENTS IN OR RELATING TO A COMPOSITE WALL OF A DEVICE

(71) Applicant: LIGHTCAST DISCOVERY LTD, Cambridge, Cambridgeshire (GB)

(72) Inventors: Thomas Henry ISAAC, Cambridgeshire (GB); Richard Jeremy INGHAM, Cambridgeshire (GB); Lindsey IBBOTSON, Cambridgeshire (GB); Timothy James PUCHTLER, Cambridgeshire (GB); William DEACON, Cambridgeshire (GB); Gareth William Harry EVANS, Cambridgeshire (GB); Robert WOOTTON, Cambridgeshire (GB)

(21) Appl. No.: 19/105,539

(22) PCT Filed: Aug. 22, 2023
(86) PCT No.: PCT/GB2023/052189

§ 371 Date: Feb. 21, 2025

(30) Foreign Application Priority Data
Aug. 23, 2022 (GB) 2212263.4

(51) Int. Cl. B01L 3/00

(52) U.S. Cl. CPC B01L 3/502792; B01L 3/502715; B01L 2200/0673; B01L 2300/0816; B01L 2300/0851; B01L 2400/0427

(57) ABSTRACT

A composite wall for an oEWOD or EWOD device is provided. The composite wall comprising: a substrate; a conductor layer provided on the substrate; a dielectric layer provided on the conductor layer; a port extending through the composite 5 wall; and an insulator configured to separate a microdroplet from the conductor layer as the microdroplet passes through the port. A method of manufacturing the composite wall is also provided.

The present invention relates to a composite wall and in particular, to a composite wall for an electrowetting-on-dielectric (EWOD) or optically-mediated electrowetting (oEWOD) device. The present invention also relates to a method of manufacturing a composite wall.

Electrowetting-on-dielectric (EWOD) is a well-known effect in which an electric field applied between a liquid and a substrate makes the liquid more wetting on the surface than the natural state. The effect of electrowetting can be used to manipulate microdroplets (e.g., controlling the movement, merging, splitting or changing shape of microdroplets) by applying a series of spatially varying electrical fields on a substrate to increase the surface wettability following the spatial variations in a sequence.

A variant of this approach uses optically-mediated electrowetting forces to provide the motive force in a device for manipulating microdroplets. In this optically mediated electrowetting (oEWOD) device, the microdroplets are translocated through a microfluidic space defined by containing walls; for example a pair of parallel plates having the microfluidic space therebetween. At least one of the containing walls includes what are hereinafter referred to as ‘virtual’ electrowetting electrode locations, which are generated by selectively illuminating an area of a semiconductor layer buried within. By selective illumination of the layer with light from a separate light source, controlled by an optical assembly, a virtual pathway of virtual electrowetting electrode locations can be generated transiently along which the microdroplets can be caused to move.

In order to form ‘virtual’ electrowetting electrodes in the walls of the EWOD or oEWOD device, at least one of the containing walls comprises a composite layer structure with the conducting layer buried within the walls.

For an EWOD or oEWOD device to be used in an environment with non-atmospheric pressure, it must be sealed. This is carried out by ensuring the composite layer, and optionally any spacer structures within the device, wrap the entire device to define an enclosed area. This reduces gas exchange with the atmosphere.

When the device is sealed, in order to be able to introduce microdroplets into the gap between the two walls in the device where they can then be manipulated by an EWOD or oEWOD method, one or more ports are provided to connect the interior space within the device to the outside. These ports may be gaps in the layers or the spacer structures to allow microdroplets to be passed in from the side without passing through the composite walls; or they may be ports through the composite walls.

During the manufacturing of the composite wall of an EWOD or oEWOD device, the port of the composite wall may be formed by laser drilling through the layers of the composite wall. This process exposes a thin region of the ITO layer that provides the bias voltage to the oEWOD device. When the microdroplets go through the composite walls via the port, they must pass through the conducting layer. It is important to be able to load microdroplets into the device whilst a voltage is maintained across the device, because this voltage is used to retain other droplets that have already been placed into the microfluidic device in position. However, when a voltage is applied to the conducting layer, one or more droplets passing through the port can come into contact with the conducting layer on the composite wall. High electric fields are known to cause the coalescence of droplets, as well as other adverse effects such as the electrolysis of the droplet medium and splitting of the droplets As a result of the contact between the microdroplets and the conducting layer, the microdroplets may get trapped or merge with each other at the port, or they may be disintegrated. Thus, this means that droplets may not be loaded into the microfluidic device in an efficient manner. Droplets which enter the microfluidic device may have a higher variation in their sizes; an input of droplets which is substantially monodisperse in volume may become polydisperse after transiting through the port; polydispersity is highly undesirable for many subsequent droplet assays and manipulations.

Moreover, the voltage applied directly across the aqueous microdroplets may drive electrolysis in the microdroplet. This can damage or even destroy the biomolecules and cells contained within the microdroplet. As described above, it has been hypothesised that the emulsion disruption i.e. electrolysis and coalescence of microdroplets can be caused by the voltage carried on the exposed conductor layer. Coalesced microdroplets can form a large aqueous plug and this can cause significant damage to the cells within the aqueous plug. This effect is particularly strong when loading a high-density emulsion, and the effect manifests as the injected material being a large volume of continuous aqueous fluid (aqueous plug) rather than a stream of monodisperse microdroplets.

Therefore, there is a requirement to provide a device and a method for efficiently loading droplets into a microfluidic device without droplets merging together or getting trapped at the port. Furthermore, there is also a requirement to minimise or eliminate droplet disruption (electrolysis and coalescence) caused by the voltage carried on the exposed conductor layer.

It is against this background that the present invention has arisen.

According to an aspect of the present invention, there is provided a composite wall for an oEWOD or EWOD device, the wall comprising: a substrate; a conductor layer provided on the substrate; a dielectric layer provided on the conductor layer; a port extending through the composite wall; and an insulator configured to separate a microdroplet from the conductor layer as the microdroplet passes through the port.

The invention as disclosed herein comprises a composite wall of a microfluidic device and in particular, the composite wall of a EWOD or an oEWOD device. According to the present invention, the insulator layer of the composite wall is configured to separate the microdroplet from contacting the conductor layer as the microdroplet passes through the port of the composite wall. Preventing contact of microdroplets with the conductor layer can be advantageous because it can minimise or eliminate droplet disruption (electrolysis and coalescence) caused by the voltage carried on the exposed conductor layer.

In addition, the composite wall provides a further advantage in that it can be used to prevent microdroplets merging together or getting trapped around the port or wetting on to the surfaces of the port. This enables a user to load the droplets efficiently into the microfluidic device to perform experiments.

In some embodiments, the insulator layer may be at least a part of the dielectric layer provided on the conductor layer. The conductor layer provided around the loading ports may be fully encapsulated by the dielectric layer. This configuration prevents droplets from contacting the conductor layer upon entry or loading into the device. Thus, it can help prevent droplet disruption by minimising the effects of coalescence and/or electrolysis as the microdroplet passes through the port. In some embodiments, the dielectric layer lines the port and thereby provides the insulator. In these embodiments, the dielectric layer can encapsulate at least the conductor layer around the vicinity of the port, such that the conductor layer does not contact the microdroplets passing through the port. This is advantageous as the insulator therefore has the same breakdown voltage as the part of the dielectric layer forming the composite wall.

As used herein, and unless otherwise specified, the phrase “in the vicinity of the port” is used to refer to an area of the port and/or an area near to the port, including the walls of the port, the margins of the port and the region of the substrate adjacent to the margin of the port. In particular, it is used with reference to an area of the port and/or an area near the port where the conductor layer is unable to contact the microdroplets when they pass through the port. For example, an insulator layer may be provided to encapsulate at least the conductor layer in the vicinity of the port. This prevents the conductor layer contacting the microdroplet as it enters the port. In another example, the conductor layer recesses away from the vicinity of the port so that the conductor layer does not contact the microdroplet as it passes through the port.

Moreover, the device can provide continuous loading of emulsions into the device whilst constantly taking the injected microdroplets into the device under oEWOD control. In some embodiments, the microdroplets may contain one or more cells. The microdroplets may also contain a medium, such as a cell medium and/or a buffer solution. In addition, the configuration of the device can help preserve the integrity of cells, biomolecules and chemical reagents contained within the microdroplets. It may also improve the monodispersity of microdroplets loaded into the device.

The device is particularly suitable for use with droplets that are supplied from an emulsifier connected upstream of the device and connected to a hole in the device. The upstream emulsifier may be a T-junction emulsifier, a cross-flow junction emulsifier or a step emulsifier or a membrane emulsifier or any other device(s) for imparting shear to fluids. Such emulsifiers may generate droplets of varying size, composition and density. They may generate emulsions with varying ratios of continuous and dispersed phase. Any of these parameters may influence the susceptibility of the droplets to merging, disintegration, electrolysis or other deleterious effects as they enter the device through the loading ports. Advantageously, the present invention allows for a wide range of emulsions to be loaded into the device without disruption. In addition, the present invention advantageously allow for a wide range of emulsions and different emulsifier types to be used to supply the device.

The configuration of the device may enable the handling of more fragile emulsions e.g. emulsions which have lower concentrations of stabilising surfactant molecules, or which contain emulsion-destabilising materials such as buffers, salts, proteins or alcohols. The configuration of the device may enable the handling of emulsions having very high fractions of dispersed phase within the continuous phase, or emulsions in which the ratio between dispersed and continuous phase is variable.

In some embodiments, the insulator may be provided by a gap or recess in the conductor layer. In some embodiments, the insulator is provided by a recess formed in at least a portion of the conductor layer. This alternative configuration of the device may prevent or eliminate coalescence and/or electrolysis as the microdroplet passes through the port.

In some embodiments, the conductor layer is an Indium Tin Oxide (ITO) layer.

Removing the ITO layer in a circular region around the port improves the performance of the device in loading, as it allows an increased voltage to be applied during loading before droplet merges occur. The removal may be accomplished by etching, laser ablation, mechanical ablation or any other suitable method. The shape of the ITO-free region may also be square, rectangular, oval or any other suitable shape. In particular, it may be shaped to follow the shape of the channel structures around the port.

In some embodiments, a part of the conductor layer can be recessed away from the vicinity of the port to provide an air gap which is the insulator. Alternatively, the air gap can be filled with a fluid such as an oil, which provides the insulator. The recessing of the conductor layer, with or without the addition of oil, ensures that the conductor layer does not contact the microdroplet as it passes through the port.

In some embodiments, the air gap can collapse and be closed off by the remaining layers in the composite wall. Those remaining layers which collapse into the air gap provide the insulator as they prevent contact between microdroplets and the conductor layer.

The dielectric layer may be made from Al₂O₃ or SiO₂, or SiN₄ (silicon nitride). In some embodiments, the dielectric layer may line the port to provide the insulator. In some embodiments, the first and/or the second dielectric layers may be composed of a single dielectric material. In some embodiments, the dielectric layer may comprise a composite stack containing more than one material in a layered structure.

The dielectric layer applied to the region around the port, in order to form the insulator, may be of a different thickness and/or made from a different material from the dielectric layer applied to the remainder of the device. The dielectric material in the region around the port may be, but is not limited to, a plastic, an inert coating such as Teflon AF, a glass, a ceramic such as hafnia, silicon nitride or any other suitable dielectric material.

Alternatively, the ITO layer could be coated with the dielectric layer to prevent the ITO layer from contacting the microdroplet as it passes through the port.

In some embodiments, the port may have a constant diameter. Alternatively, the diameter of the port may include at least one step change in diameter. For example, the dielectric layer may not line the entire surface area of the port, but may leave part of the substrate unlined. This provides a larger cross sectional area part of the port. In some embodiments, the port may have an increasing diameter in the direction of travel of the droplets. In some embodiments, the port may have a decreasing diameter in the direction of travel of the droplets.

In some embodiments, the substrate can define a plane and the port extends through the composite wall in a direction substantially perpendicular to the plane. This may simplify manufacturing procedures which in turn, makes the manufacturing process cost-effective and efficient.

Alternatively, the port may extend at an acute angle to the plane of the substrate. An angled port could change the stresses on the microdroplet resulting in a lower shear stress as the microdroplet transitions from the port into the microfluidic space between the first and second composite walls. By reducing the shear stress, the cells held within the microdroplet are likely to have an improved outcome in comparison with a higher shear stress transition.

In some embodiments, the port may be provided at an acute angle relative to the composite wall. By providing a port at an acute angle relative to the composite wall, the microdroplets can be guided into the port in a particular direction. This may be useful in reducing electrolysis or electro-coalescence of the microdroplets.

In some embodiments, the composite wall may further comprise a photoactive layer provided between the conductor layer and the dielectric layer. In some embodiments, the photoactive layer can be made out of amorphous silicon.

The photoactive layer can be formed from a semiconductor material which can generate localised areas of charge in response to stimulation by the source of electromagnetic radiation. Examples include hydrogenated amorphous silicon layers having a thickness in the range 100 to 1500 nm. Preferably, the amorphous silicon layer may have thickness in the range 400 to 800 nm. In some embodiments, the amorphous silicon layer may have a thickness of less than 100 nm. In some embodiments, the thickness of the amorphous silicon layer may exceed 1500 nm. In some embodiments, the photoactive layer is activated by the use of visible light.

The dielectric properties of this layer, when it is not illuminated, preferably include a high dielectric strength of >10E7 V/m and a dielectric constant of >3.

In some embodiments, the dielectric layer is selected from alumina, silica, hafnia or a thin non-conducting polymer film.

The novel device design permits the use of holes within the device that are fabricated with a range of methods including laser drilling, diamond drilling, sandblasting and wet etching. Other methods of fabricating the one or more holes include the use of a laser process to modify the glass substrate of the device followed by a wet etching process, and the use of an isotropic etching process such as reactive ion etching or inductively coupled plasma etching.

Some of these hole fabrication processes may leave a rough and misshapen surface that will likely expose a portion of the conductor layer within the layer structure of the oEWOD device.

The configuration of the device as disclosed herein allows for the holes to be drilled within either the photoactive layer or the passive sides of the oEWOD device without the disadvantages associated with coalescence and electrolysis.

In some embodiments, the inner wall of the port may be annealed, polished, etched or ablated in order to provide a smooth finish. This is advantageous as it prevents roughness on the surface of the walls disrupting the integrity of emulsion as it passes through the ports.

In some embodiments, the photoactive layer may line the port to provide the insulator.

In some embodiments, the photoactive layer and the dielectric layer may line the port to provide the insulator.

In some embodiments, the composite wall as disclosed herein can provide a suitable surface upon which to attach further coating layers such as a hydrophobic coating and/or an anti-fouling coating layer.

Advantageously, the lining of the port with an insulator allows for the interior surface of the port to be coated with a hydrophobic layer. The presence of a hydrophobic layer in the vicinity of the port can reduce the size of the contact patch between the droplets of the emulsion and the inner layer of the hole. It may also prevent the wetting of the droplets on to the wall. As such, the addition of a hydrophobic layer can further reduce the amount of coalescence and droplet disruption caused by the transit of the emulsion through the ports in the composite wall. The hydrophobic layer may also perform the function of being an anti-fouling layer.

The hydrophobic layer may be a monolayer of (1H, 1H,2H,2H-perfluorooctyl)silane, deposited by incubation with 1H,1H,2H,2H-perfluorooctyltrimethoxysilane or 1H, 1H,2H,2H-perfluorooctyltrichlorosilane introduced as a vapour following low pressure oxygen plasma treatment of the surfaces of the composite wall. In some cases, the coating material is introduced in several discrete steps, at each step removing the coating material from the atmosphere around the substrate before introducing a new pulse of material. In some cases, the substrate may be heated or incubated with water vapour following each deposition stage.

In some embodiments, the conductor layer may recess away from the vicinity of the port by at least 0.001 mm. By providing a recess of the conductor layer of at least 0.001 mm away from the vicinity of the port, it gives the minimum distance required for the droplets not to contact the conductor layer as it passes through the port.

In some embodiments, the conductor layer may recess away from the vicinity of the port by at least 0.001 mm, at least 0.01, at least 0.1 mm, at least 1 mm or at least 2 mm.

The conductor layer may recess away from the vicinity of the port by a distance between 0.001 to 0.01 mm, 0.01 to 2 mm, or it may be more than 0.001, 0.005, 0.01 mm, 0.05 mm, 0.1 mm, 0.5 mm, 1 mm, 1.5 mm or 2 mm. In some embodiments, the conductor may recess away from the vicinity of the port of less than 2 mm, 1.5 mm, 1 mm, 0.5 mm, 0.1 mm, 0.05, 0.01, or 0.005 mm.

In some embodiments, the port may be substantially circular. Providing a circular port may be more energetically favourable as it funnels the microdroplets through the port in a more favourable direction. A circular port lacks the corners that will cause low-flow regions under the laminar flow conditions typically encountered in microfluidic devices, and such low flow regions may trap microdroplets. In the case where the port is angled with respect to the faces of the composite walls, the entrance and exit of the port may be oval shaped, with the ovals also lacking low-flow corner features.

In some embodiments, the port may be substantially square shaped. Providing a square-shaped port may be advantageous as it can me more readily manufactured by processes such as laser-cutting, or a punch process. The skilled person in the art would consider other shapes and sizes of the port. The port can have a smooth or a rough surface. In some embodiments, the shape of the port can be tapered or flared.

According to another aspect of the present invention, there is provided a composite wall for an oEWOD or EWOD device, the wall comprising: a substrate;
a conductor layer provided on the substrate; a dielectric layer provided on the conductor layer; and a port extending through the composite wall for allowing a microdroplet to pass there through; wherein the port is configured to insulate the microdroplet from the conductor layer.

According to a further aspect of the present invention, there is provided an oEWOD or a EWOD device comprising a first composite wall and a second composite wall, one of which is a composite wall as described above.

According to a further aspect of the present invention, there is provided an oEWOD or a EWOD device comprising two composite walls, one of which is a composite wall as described above.

In some embodiments, the first and/or the second conductor layers can be made of a transparent conductive material such as Indium Tin Oxide (ITO), a very thin film of conductive metal such as silver or a conducting polymer such as PEDOT or the like. These layers may be formed as a continuous sheet or a series of discrete structures such as wires. Alternatively, the conductor layer may be a mesh of conductive material with the electromagnetic radiation being directed between the interstices of the mesh.

The first substrate and the first conductor layer and/or the second substrate and the second conductor layer may be transparent. The substrate may be made out of glass or plastic.

The first and/or the second dielectric layers may be composed of a single dielectric material or it may be a composite of two or more dielectric materials. The dielectric layers may be made from, but is not limited to, Al₂O₃ and SiO₂.

In some embodiments, the second composite wall comprises: a substrate; a conductor layer provided on the substrate; and a dielectric layer provided on the conductor layer.

In some embodiments, the two composite walls can be separated by a gap of between 5 microns to 2000 microns. In some embodiments, the gap can be 5 to 1750 microns, 5 to 1500, 5 to 1250 microns, 5 to 1000 microns, 5 to 750 microns, 5 to 500 microns, 5 to 250 microns, 5 to 100 microns, 5 to 75 microns, 5 to 50 microns, 5 to 25 microns. In some embodiments, the two composite walls can be separated by a gap of between 20 to 120 microns. In some embodiments, the two composite walls are separated by a gap of between 20 to 120 microns, but it may be more than 20, 30, 40, 50, 60, 70, 80, 90, 100 or 110 microns. In some embodiments, the two composite walls are separated by a gap of less than 120, 110, 100, 90, 80, 70, 60, 50, 40 or 30 microns. In some embodiments, the two composite walls are separated by a gap of between 20 to 40 microns. In some embodiments, the gap may be 30 microns or 40 microns.

In some embodiments, the oEWOD device may comprise the following: a first composite wall comprising: a first substrate; a first conductor layer on the substrate; a photoactive layer on the conductor layer; and a first dielectric layer on the photoactive layer having a thickness of less than 20 nm; a second composite wall comprising: a second substrate; a second conductor layer on the substrate; and a second dielectric layer on the second conductor layer having a thickness of less than 20 nm.

In some embodiments, the first and second composite walls are held apart to form a microfluidic space therebetween. The walls can be separated by a spacer structure, which may be formed by an interposing structure between the first and second substrates, or it could be formed from the substrates of the first or second composite walls.

The spacer may be formed from a layer of photoresist, by a layer of pressure-sensitive adhesive and/or by a layer of dry-film resist. Additionally or alternatively, it may be formed by etching structures and/or cavities in to a glass, fused silica or transparent plastic substrate that forms the first or second composite walls.

In some embodiments, the oEWOD device can be formed from two glass substrates interposed by a spacer of laser-cut pressure sensitive adhesive. The holes and channels can be formed by laser drilling and ablation of the glass substrates. Thereafter, the remaining layers of the composite walls are deposited such that a conducting ITO layer, the photoactive layer, the overlaying dielectric layers and a hydrophobic layer line the inner wall of the port.

In some embodiments, the first and/or second dielectric layer may be a continuous layer. Moreover, the first and/or second dielectric layer may be a thickness of between 1 nm to 20 nm, or it may be 2 nm to 20 nm, 3 nm to 20 nm, 4 nm to 20 nm, 5 nm to 20 nm, 6 nm to 20 nm, 7 nm to 20 nm, 8 nm to 20 nm, 9 nm to 20 nm, 10 nm to 20 nm, 12 m to 20 nm, 14 nm to 20 nm, 15 nm to 20 m or 18 nm to 20 nm. It may also be 1 to 15 nm, 1 to 10 nm, 1 to 5 nm, 5 to 10 nm, 5 to 15 nm or 10 to 15 nm.

The oEWOD device may further comprise a voltage source, such as an A/C voltage source, to provide a voltage across the first and second composite walls connecting the first and second conductor layers; at least one source of electromagnetic radiation having an energy higher than the bandgap of the photoexcitable layer adapted to impinge on the photoactive layer to induce corresponding ephemeral electrowetting locations on the surface of the first dielectric layer; and a microprocessor for manipulating the points of impingement of the electromagnetic radiation on the photoactive layer so as to vary the disposition of the ephemeral electrowetting locations thereby creating at least one electrowetting pathway along which the microdroplet may be caused to move.

The A/C source may be configured to provide a voltage of between 1 V and 100 V across the first and second composite walls connecting the first and second conductor layers. In some embodiments, the A/C source may be configured to provide a voltage of between 0.01 to 1V, 0.05 V to 1 V, 1 to 5 V, 1 to 7V, 1 to 10 V, 1 to 15 V, 1 to 20 V, 1 to 25 V, 1 to 30 V, 1 to 40 V, 1 to 50 V, 1 to 60 V, 1 to 70 V, 1 to 80 or 1 to 90 V.

In some embodiments, the source of electromagnetic radiation may be an LED light source. In some embodiments, the source(s) of electromagnetic radiation may comprise a pixellated array of light reflected from or transmitted through such an array of active pixel elements. Where the source of electromagnetic radiation is pixelated, it is suitably supplied either directly or indirectly using a reflective screen illuminated by light from LEDs.

The first and second composite walls may further comprise first and second anti-fouling layers on respectively the first and second dielectric layers. The anti-fouling layer on the second dielectric layer may be hydrophobic.

The first and/or second conductor layer on the substrate may be a thickness in the range 70 to 250 nm. In some embodiments, the thickness of the first and/or second conductor layer may be more than 70, 80, 90, 100, 110, 120, 130, 140, 150, 160, 170, 180, 190, 200, 210, 220, 230 or 240 nm. In some embodiments, the thickness of the first and/or second conductor layers may be less than 250 nm, 240, 230, 220, 210, 200, 190, 180, 170, 160, 150, 140, 130, 120, 110, 100, 90 or 80 nm.

The photoactive layer may be activated by electromagnetic radiation in the wavelength range 400 to 1000 nm on the conductor layer. In some embodiments, the photoactive layer may be activated by electromagnetic radiation in the wavelength of 400 to 500 nm, 400 to 600 nm, 400 to 700 nm, 400 to 800 nm or 400 to 900 nm.

The device may further comprise a photodetector to detect an optical signal in the microdroplet located within or downstream of the device. The optical signal may be a fluorescence signal.

According to a further aspect of the present invention, there is provided a cartridge comprising: at least one inlet port for introducing a sample, such as a liquid sample, into the cartridge; at least one emulsifier configured to produce microdroplets; a device (or chip) comprising a first and second composite walls according to any one of the aspects of the present invention, the walls having a microfluidic space therebetween for EWOD or oEWOD microdroplet manipulation; and an emulsion handling channel configured to provide fluid communication between the emulsifier and the device.

A cartridge may be provided. The cartridge may comprise: a reservoir configured to contain a sample such as a liquid sample; an emulsifier in a fluidic circuit with the reservoir, the emulsifier is configured to generate a medium comprised of an emulsion of aqueous microdroplets in an immiscible carrier fluid; an inlet channel provided downstream of the emulsifier, wherein the inlet channel is configured to receive the medium comprised of the emulsion of aqueous microdroplets in the immiscible carrier fluid from the emulsifier; a composite wall or a device according to any one of the aspects of the present invention, whereby the device comprises at least an inlet port and the device is in fluid communication with the inlet channel; and a pumping system provided to induce the flow of the sample e.g. a liquid sample to at least one emulsifier and/or induce the flow of the medium comprised of the emulsion of aqueous microdroplets in the immiscible carrier fluid through the device.

Suitably, the aqueous fluids within the cartridge may be biological fluids such as cell media, and they may contain cells, beads, particles, drugs, biomolecules or other biological entities. These entities may be viruses, DNA or RNA molecules, stimulants, cytokines, nutrients and dissolved gases. As such the design of the cartridge channels and structures may be optimised such that the dispersion and integrity of the biological fluids is preserved, particularly by selection of well-matched channels of even hydraulic diameter and minimal fluid shear.

In some embodiments, the cartridge may further comprise one or more valves provided at the inlet port of the device, wherein the valve controls the flow of the medium, comprised of the emulsion of aqueous microdroplets in the immiscible carrier fluid, through the device.

In some embodiments, the emulsifier may be a step emulsifier. Advantageously, a step emulsifier generates emulsion with a microdroplet size distribution that has a minimal dependency on the flow velocities at the emulsification junction. In some embodiments, the cartridge may comprise a plurality of emulsifiers. At least one of the emulsifiers is a step emulsifier. In some embodiments, several emulsifiers may be provided, each of which is provided with an inlet channel. In some embodiments, the cartridge assembly may contain up to eight emulsifiers. In some embodiments, the cartridge assembly may contain at least 1, 2, 3, 4, 5, 6 or 7 emulsifiers. In some embodiments, the cartridge assembly may contain between 8 and 12 emulsifiers. In some embodiments, the cartridge assembly may contain between 12 to 20, 20 to 30, 30 to 50 or 50 to 100 emulsifiers. The emulsifiers may be interchangeable by the user such that the user can choose a suitable type of emulsifier for their intended purposes. For example, the user may configure a cartridge with emulsifiers that provide a particular microdroplet size range. The user may choose a set of emulsifiers each providing microdroplets with a different size range, or a sub-selection of size ranges. In some embodiments, the emulsifiers may be configured to generate microdroplets of volumes in the range 14 pL to 180 pL, or microdroplets in the range 180 pL to 500 pL, or in the range 500 pL to 1.2 nL.

Furthermore, it is possible to parallelise the operation of a set of step emulsifier nozzles within a single emulsifier device, so that multiple emulsification nozzles are connected to a single aqueous input. The connected nozzles can run independently with variation in speeds determined by the complex interplay between the interconnected junctions. The emulsifiers can all generate microdroplets of substantially uniform size determined by the physical size of the nozzles. This allows for a large number of generators running in parallel at low flow velocities, eliminating the deleterious effects of shear that can damage cells and other biological materials. It also allows the emulsifier to continue generating emulsion despite the partial occlusion or blocking of some nozzles that is the occasional consequence of running biological material comprising particulates through narrow nozzle apertures.

In some embodiments, the pumping system can include, but is not limited to, a pump, a head reservoir, an accumulator and/or a pressure source. It will be further appreciated that the skilled person in the art would know other pumping system that could be used to induce the flow of the liquid sample to the emulsifier and/or induce the flow of the medium through the device.

The device may further comprise a plurality of first electrowetting pathways running concomitantly to each other. The device may further comprise a plurality of second electrowetting pathways adapted to intersect with the first electrowetting pathways to create at least one microdroplet-coalescing location.

The sample can be a fluid sample, such as a liquid sample, and the sample can contain at least one biological and/or chemical entity. The sample may be an aqueous fluid, an aqueous media, a buffer solution, a suspension or a particulate.

The biological and/or chemical entity can be a cell. The biological and/or chemical entity may be a biomolecule such as a nucleic acid, such as RNA, DNA or a hybrid thereof, a protein, polysaccachrides, a peptide or polypeptide such as a hormone, enzyme, cell signalling molecule, signal transduction molecule, immunoglobulins and the like, an antibody and/or antibody fragment thereof. The biological and/or chemical entity may be a chemical, such as a pesticide, a toxin, an antibiotic, a fuel, a pharmaceutical drug, a vaccine, an antiviral and the like. The biological and/or chemical entity can be a carbohydrate, an antibody or a fragment thereof, a microbead, a particle, a compound and/or a drug.

Other biological and/or chemical entities may also be viruses, stimulants, cytokines, nutrients and/or dissolved gases. The cells may be of the same type, for example they are B cells or T cells (lymphocytes). It may be desirable to analyse co-cultures where the cells within the droplets are of disparate types such as a combination of reporter cells and primary cells, or a culture combining epithelial cells of different phenotypes to form a tissue-like structure. The cell(s) may be natural. The cell(s) may be artificial. The cell(s) may be microcells. The cell(s) may be a biological cell. The biological entity may be part(s) of a cell(s), for example nuclei and/or mitochondria.

The cells may be taken from any appropriate source, for example a cell sample from a human or animal, plant or microorganism. The cell may be a cell from a human or animal, optionally a mammal. The cell may be a plant cell, insect cell, fungal cell, bacterial cell or ameobal cell. The cell may be a cell-fusion such as a hybridoma.

The cells may be taken from a cell culture, for example a culture of stem cells, pluripotent cells, genetically engineered cells and the like.

If the cell is derived from a sample/biological sample this may be any human, animal, environmental (natural, contrived or modified), or food sample containing at least one cell type. The sample/biological sample may be selected from: stool, peripheral blood, sera, plasma, ascites, urine, cerebrospinal fluid (CSF), sputum, saliva, bone marrow, synovial fluid, aqueous humour, amniotic fluid, cerumen, breast milk, broncheoalveolar lavage fluid, semen, prostatic fluid, cowper's fluid or pre-ejaculatory fluid, female ejaculate, sweat, faecal matter, hair, tears, cyst fluid, pleural and peritoneal fluid, pericardial fluid, lymph, chyme, chyle, bile, interstitial fluid, menses, pus, sebum, vomit, vaginal secretions, mammary secretions, mucosal secretion, stool water, pancreatic juice, lavage fluids from sinus cavities, bronchopulmonary aspirates, blastocyl cavity fluid, and umbilical cord blood. Alternatively, the sample may come from a tissue sample.

The cell may be isolated from a patient or individual. The cartridge of the present invention as described herein may be used to screen such cells and return them to the patient (autologous cell transfer). The cells may be isolated from one individual and selected to be administered to a patient (allogenic cell transfer).

The cell may be a human or mammalian cell. The cell may be any suitable type from any tissue type, such as from organ or tissue of the body.

The cell may be an immune system cell. Such cells include monocytes, macrophages, osteoclasts, neutrophils (polymorphonuclear leukocytes) dendritic cells, microglial cells, mast cells, T cells (including helper T cells, regulatory T cells, cytotoxic T cells and natural killer T cells), B cells, natural killer cells and hematopoietic stem cells. The cell can be a CHO cell or it can be a Jurkat cell.

According to another aspect of the present invention, there is provided a method of manufacturing the composite wall according to any aspects and embodiments of the present invention, the method comprising the steps of: providing a substrate; depositing the conductor layer onto the substrate; creating a hole in the conductor layer; depositing the dielectric layer onto the conductor layer; and creating a port through the composite wall.

In some embodiments, the method of manufacturing the composite wall comprises the step of: providing a conductor layer such as an ITO layer onto the substrate; providing a dielectric layer onto the conductor layer; and drilling into a part of the layers to create a port through the composite wall.

In this case, it is advantageous to provide a recess in the conductor of between 0.001 mm and 2 mm away from the vicinity of the port in order to increase manufacturing tolerances and thus, leads to lower error margins during the drilling operation. This can create a more efficient and cost-effective manufacturing process of the composite wall according to any one of the aspects and embodiments of the invention.

In some embodiments, the hole in the conductor layer may have a greater diameter than the port. This effectively creates the recessed embodiment although the dielectric layer will encroach into the recess in the conductor layer so that there may not be an air gap recess, but rather the edge of the conductor layer is insulated by the dielectric.

In some embodiments, the port can be created through the composite wall before the deposition of the dielectric layer and wherein the deposition of the dielectric resulting in the dielectric layer lining the port.

In some embodiments, there is provided a manufacturing method of the composite wall where the drilling step is not required. The steps may include depositing the conductor layer onto the substrate and depositing the dielectric layer onto the conductor layer.

A gap may be provided at the edge of the composite wall to provide a port. The conductor layer is provided with a recess such that when microdroplets enter through the port, the droplets do not contact with the conductor layer. Alternatively, the conductor layer is coated with a dielectric layer such that the conductor layer does not contact the droplets as it enters through the port.

According to an aspect of the present invention, there is provided a species screened by the device, apparatus or method as disclosed herein.

According to an aspect of the present invention, there is provided a species selected by the device, apparatus or method as disclosed herein.

According to an aspect of the present invention, there is provided a species isolated by the device, apparatus or method as disclosed herein.

According to an aspect of the present invention, there is provided a species made by the device, apparatus or method as disclosed herein.

The species may be chemical, biochemical, or biological in nature. For example, the present invention may provide an agonist/antagonist to an entity as identified by the screening, selection and/or isolation method disclosed herein.

The present invention may provide an agonist/antagonist to an entity as identified by the screening, selection and/or isolation method disclosed herein, for use in therapy. The entity may be chemical, biochemical, or biological in nature.

According to an aspect of the present invention, there is provided a use of the device, apparatus, method or species as disclosed herein.

According to an aspect of the present invention, there is provided a use of the device, apparatus, method or species as disclosed herein in therapy.

The present invention may provide for a use of the device, apparatus, method or species as disclosed herein in making a product. The product made may be chemical, biochemical, or biological in nature.

The use may be peptide synthesis. The use may be synthetic biology. The use may be cell line engineering or development. The use may be cell therapy. The use may be drug discovery. The use may be antibody discovery.

According to an aspect of the present invention, there is provided a use of the device, apparatus, method or species as disclosed herein in analysis.

The analysis may be physical, chemical, or biological.

The use may be sub-cellular imaging. The use may be high content imaging.

The use may be diagnostics.

The use may be a biological assay. The biological assay may be high throughput screening. The biological assay may be ELISA.

The use may be cell secretion.

The use may be QC safety profiling.

The invention will now be further and more particularly described, by way of example only, and with reference to the accompanying drawings, in which:

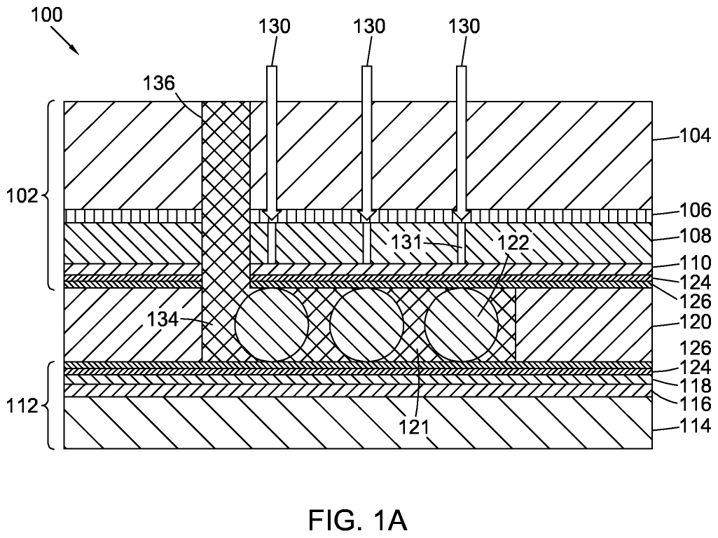

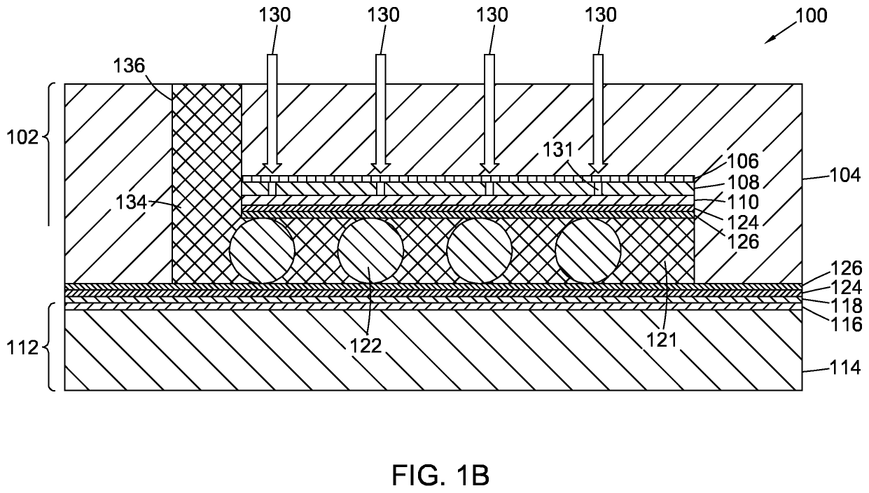

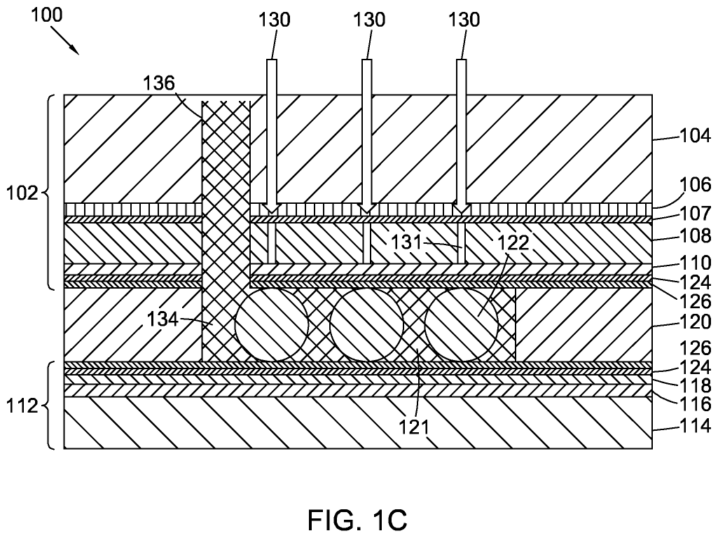

FIGS. 1A and 1B show two oEWOD device configurations according to the present invention;

FIG. 1C provides an alternative embodiment of the oEWOD device according to the present invention;

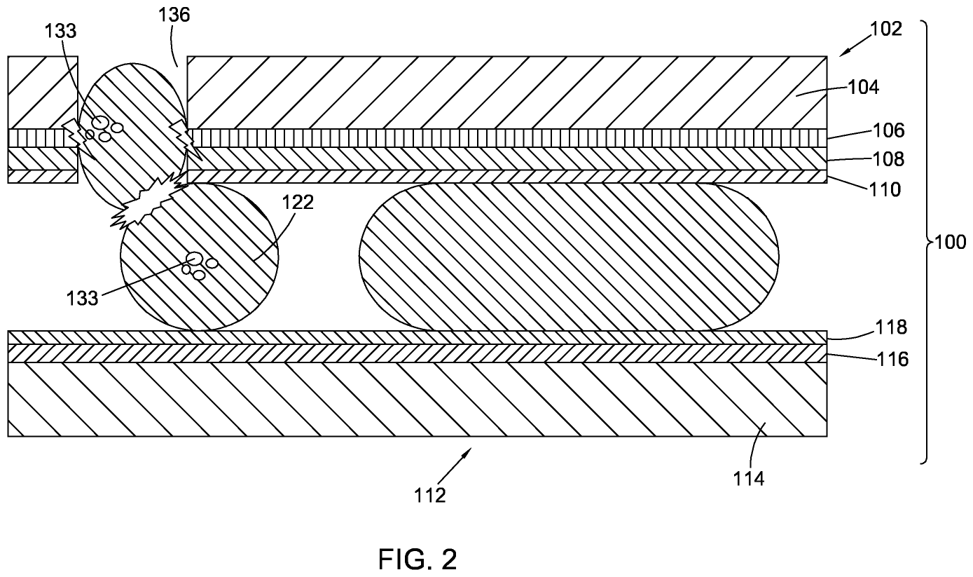

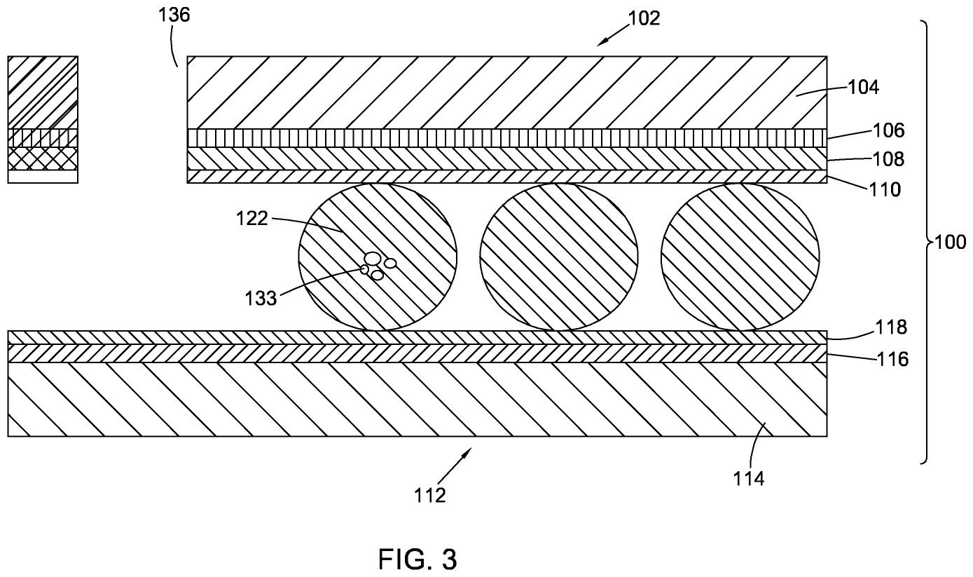

FIGS. 2 and 3 show a composite wall of a microfluidic device;

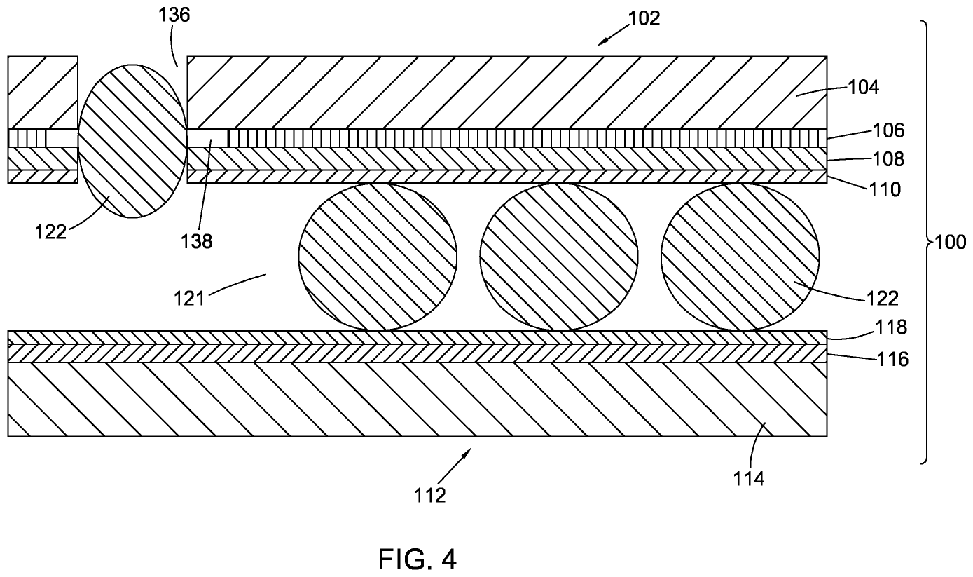

FIG. 4 shows a composite wall according to an aspect of the present invention;

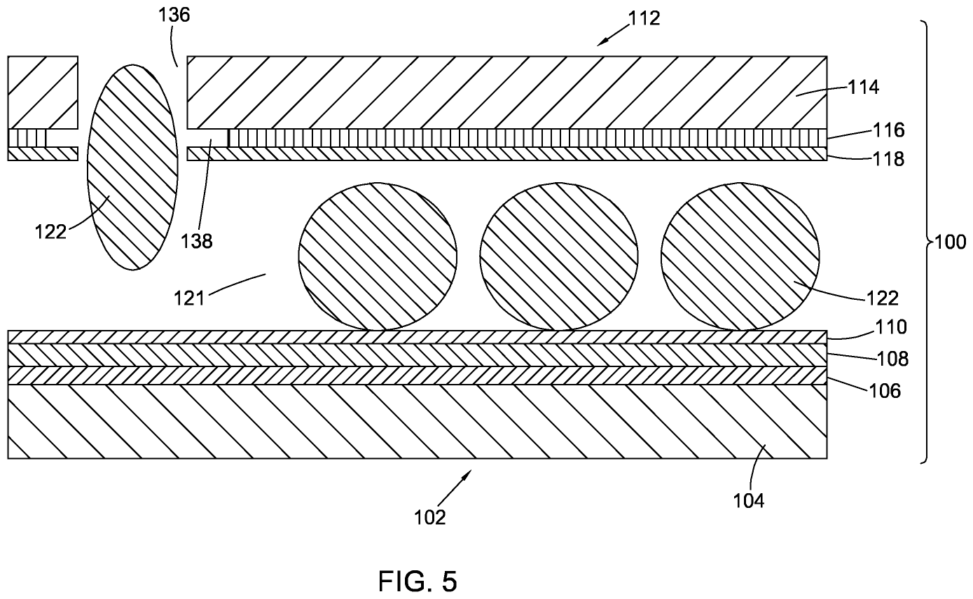

FIG. 5 shows an embodiment of the composite wall;

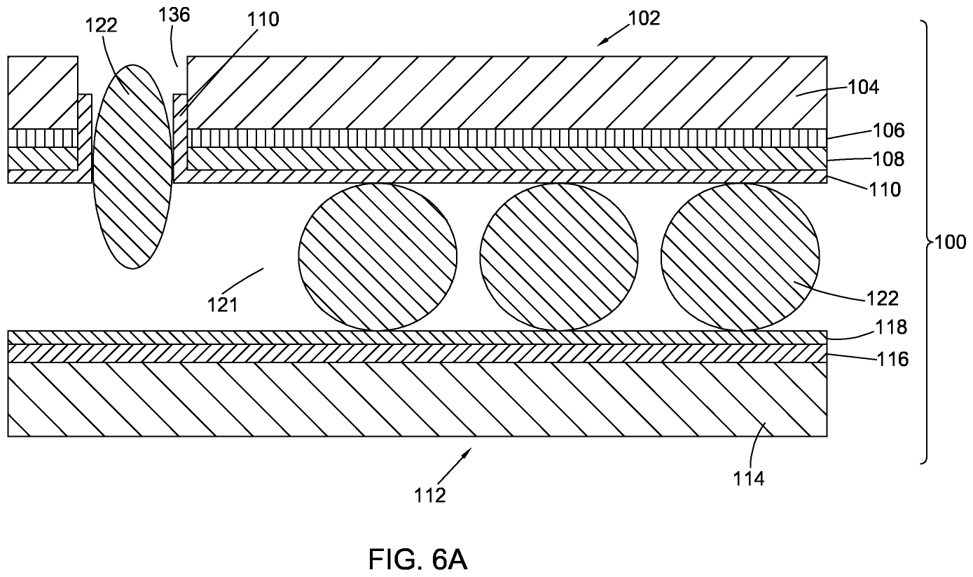

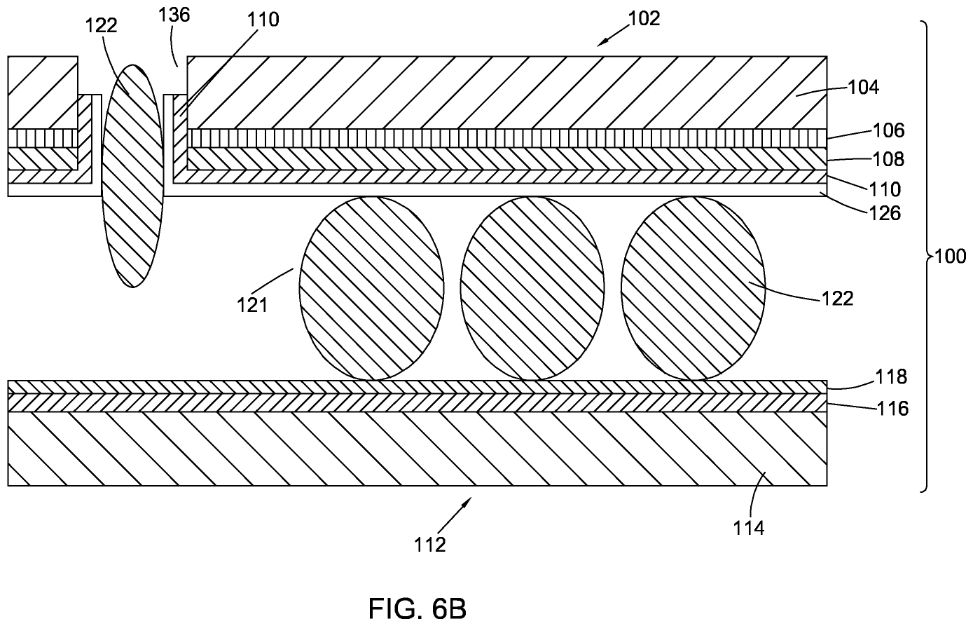

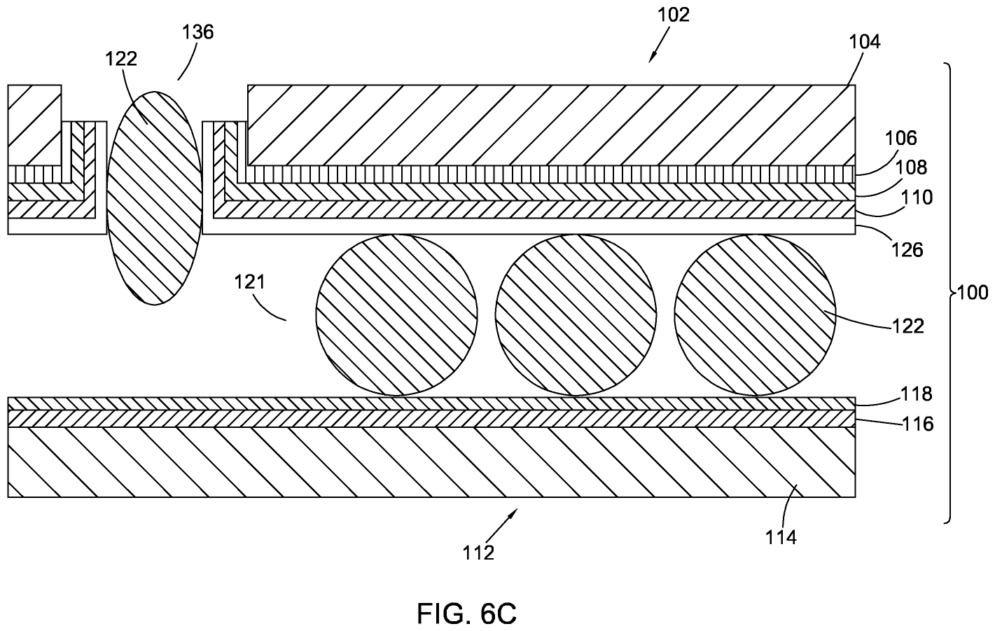

FIG. 6A shows another embodiment of the composite wall;

FIG. 6B shows an alternative embodiment of the composite wall;

FIG. 6C shows an alternative embodiment of the composite wall;

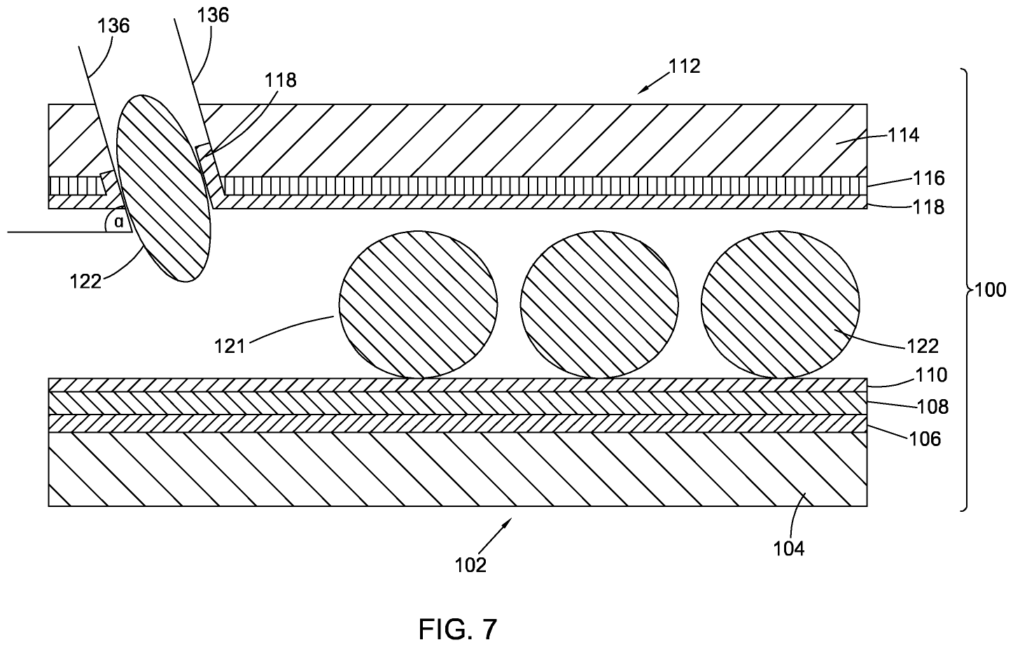

FIG. 7 shows a further embodiment of the composite wall;

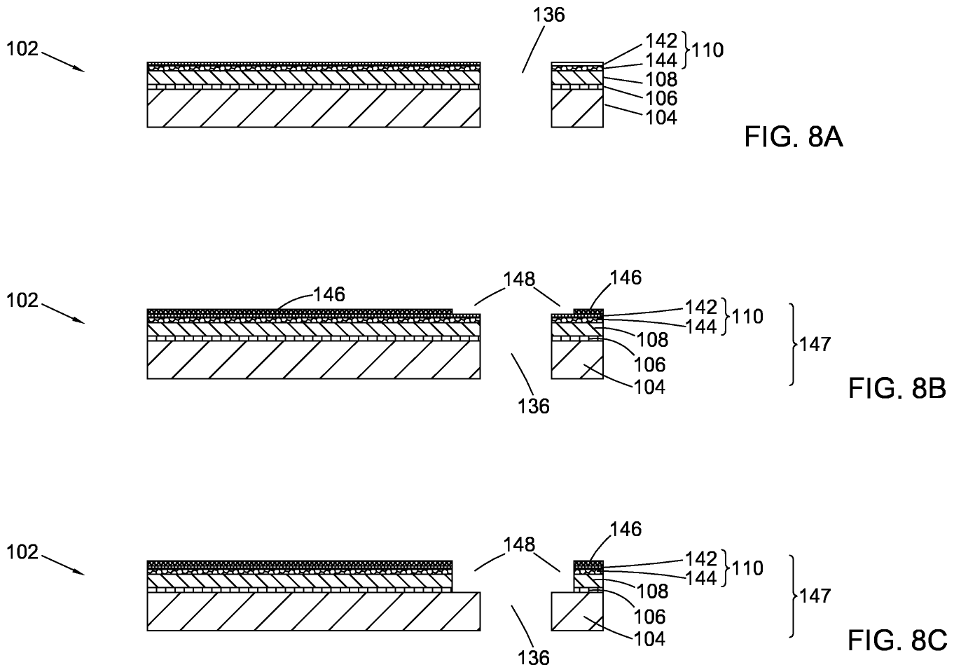

FIGS. 8A to 8C show the composite wall before, during and after an etching process;

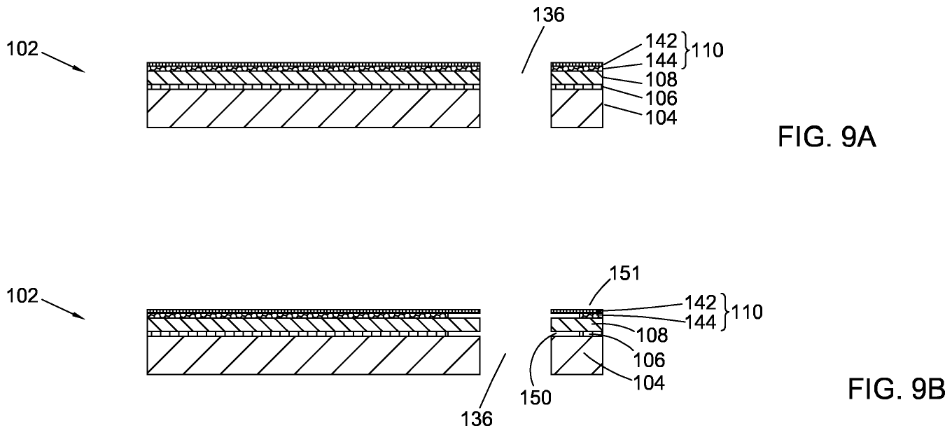

FIGS. 9A and 9B provide an illustration of an alternative etching process of at least the conductor layer of the composite wall;

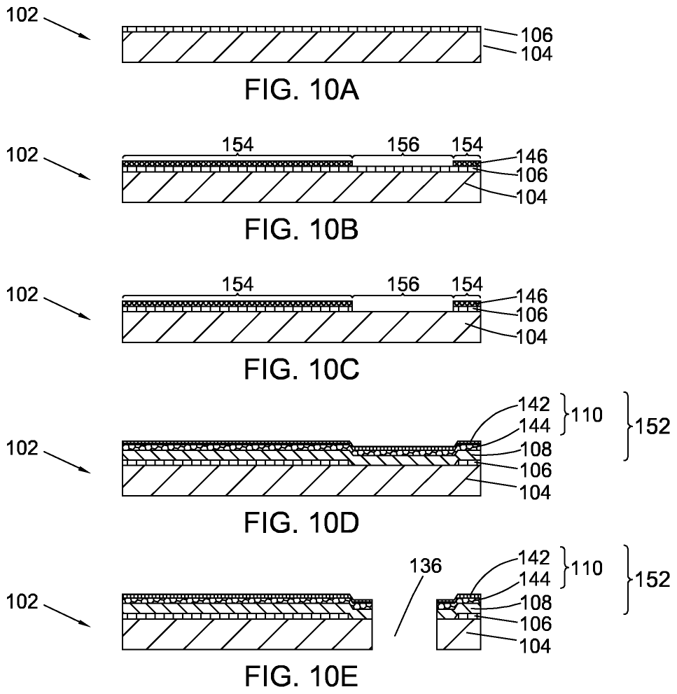

FIGS. 10A to 10E provide an illustration of an alternative etching process of the composite wall before, during and after the etching of at least the conductor layer;

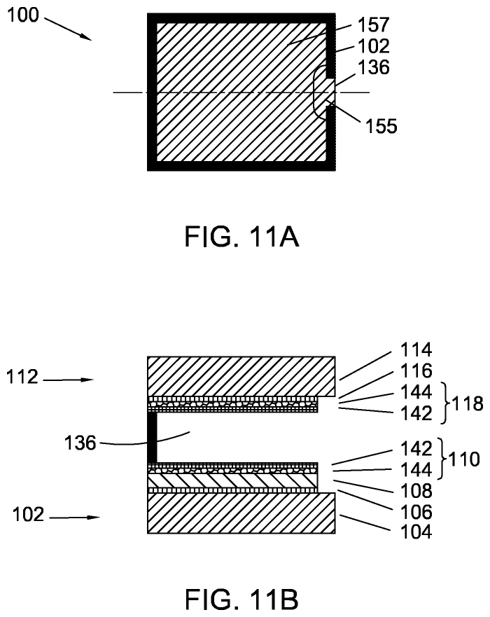

FIG. 11A shows a top view of a microfluidic device such as an EWOD or oEWOD device, with a port located through the side of the wall of the device;

FIG. 11B shows a cross sectional view of the microfluidic device after etching, illustrating the etched area created in the vicinity of the port through the side of the device;

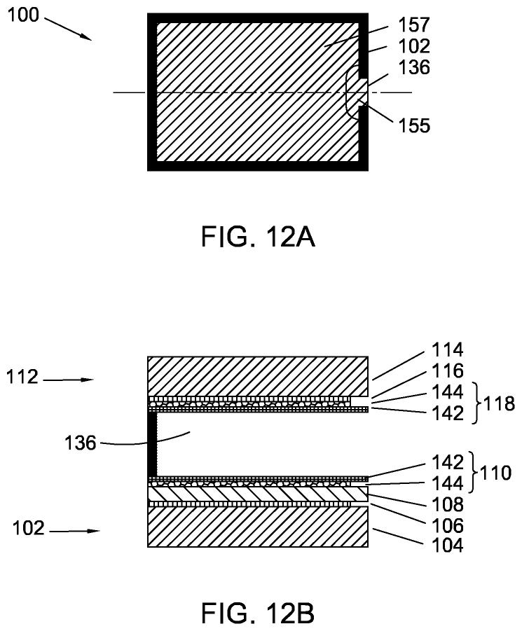

FIG. 12A shows a top view of the microfluidic device such as an EWOD or oEWOD device, with a port located through the side of the wall of the device;

FIG. 12B shows an alternative cross sectional view of the microfluidic device after etching, illustrating the etched area created in the vicinity of the port through the side of the device;

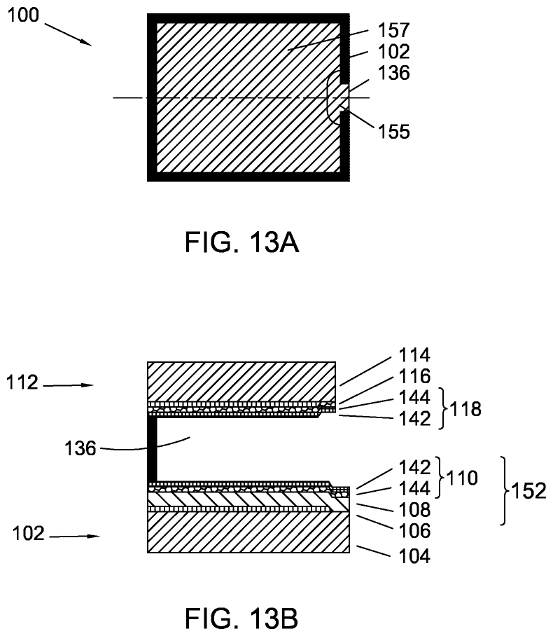

FIG. 13A shows a top view of the microfluidic device such as an EWOD or oEWOD device, with a port located through the side of the wall of the device; and

FIG. 13B shows an alternative cross sectional view of the microfluidic device after etching, illustrating the etched area created in the vicinity of the port through the side of the device.

Referring to FIG. 1A, there is provided a microfluidic device and in particular, an oEWOD device 100. The oEWOD device as illustrated in FIG. 1A comprises: a first composite wall 102 comprised of a first substrate 104, which can be made out of glass, a first conductor layer 106 on the substrate 104, the first conductor layer 106 having a thickness in the range 70 to 250 nm; a photoactive layer 108 activated by electromagnetic radiation in the wavelength range 400 to 850 nm on the conductor layer 106, the photoactive layer 108 having a thickness in the range 300 to 1500 nm and a first dielectric layer 110 on the photoactive layer 108. The first dielectric layer 110 is formed as a continuous layer that has a thickness of less than 20 nm. The lower bound for the thickness of the layer will be dictated, at least in part, by the methodology of providing such a thin layer that must be continuous. However, theoretically it could have a thickness of between 0.1 nm to 20 nm. The first conductor can be transparent.

The device 100 also comprises a second composite wall 112 comprising: a second substrate 114, which can be made out of glass and a second conductor layer 116 on the substrate 114. The second conductor can be transparent. The second conductor layer 116 may have a thickness in the range 70 to 250 nm. A second dielectric layer 118 may be on the second conductor layer 116, where the second dielectric layer 118 has a thickness of less than 20 nm. As with the first dielectric layer, the second dielectric layer must be continuous and the practical lower bound for the thickness is dictated by manufacturing constraints although it could be between 1 nm to 20 nm. The exposed surfaces of the first 110 and second 118 continuous dielectric layers are disposed 20 to 180 μm apart to define a microfluidic space 121 adapted to contain microdroplets 122.

The photoactive layer 108 is made out of amorphous silicon. The first and second conductor layers are made out of ITO. An interstitial binding layer 124 is provided on the first dielectric layer 110 and can also be provided on the second dielectric layer 118. The thickness of the interstitial layer may be between 0.1 nm to 5 nm. In some embodiments, not illustrated in the accompanying drawings, the interstitial binding layer may be omitted. In such embodiments, the hydrophobic layer is applied directly to the first dielectric layer.

A hydrophobic layer 126 is provided on the interstitial binding layer 124. An example of a hydrophobic layer could be a fluorosilane or fluorosiloxane. The interstitial binding layers 124 are optional and the channel walls 120 can be made of SU8, or it may be part of the glass structure. The interstitial layer 124 is provided between the dielectric layer 110, 118 and the hydrophobic layer 126.

An incident light 130, as illustrated in FIG. 1A, can be used to provide a light sprite pattern 131 in which the incident light 130 provides light onto a portion of the photoactive 110 to hold the microdroplet 122 into a stationary position within the microfluidic space 121. An oil carrier phase 134 can be provided to the microdroplets 122, through a hole 136 in the device, to replenish key nutrients and components to keep the contents within the microdroplet 122, such as one or more cells, alive and healthy. In some cases, the oil phase 134 can provide key nutrients, medium, media and contents for cell growth, viability and/or productivity.

The first and second substrates 104, 114 are made of a material which is mechanically strong. For example, the first and second substrates can be formed from glass, metal or an engineering plastic. In some embodiments, the substrates may have a degree of flexibility. In some embodiments, the first and second substrates have a thickness that is at least 100 μm. In some embodiments, the thickness of first and second substrates may be more than 2500 μm. In some embodiments, the first substrate is Silicon, fused silica or glass. In some embodiments, the second substrate is fused silica and/or glass. The glass may be, but is not limited to, a soda lime glass or a float glass.

The first and second conductor layers 106, 116 are located on one surface of the first and second substrates 104, 114 and typically have a thickness in the range 70 to 250 nm, preferably 70 to 150 nm. At least one of these layers is made of a transparent conductive material such as Indium Tin Oxide (ITO), a very thin film of conductive metal such as silver or a conducting polymer such as PEDOT or the like. These layers may be formed as a continuous sheet or a series of discrete structures such as wires. Alternatively, the conductor layer may be a mesh of conductive material with the electromagnetic radiation being directed between the interstices of the mesh.

The photoactive layer 108 is formed from a semiconductor material which can generate localised areas of charge in response to stimulation by the source of electromagnetic radiation. Examples include hydrogenated amorphous silicon layers having a thickness in the range 300 to 1500 nm. In some embodiments, the photoactive layer is activated by the use of visible light. The dielectric properties of this layer preferably include a high dielectric strength of >10\hat{ }7 V/m and a dielectric constant of >3. In some embodiments, the dielectric layer is selected from alumina, silica, hafnia or a thin non-conducting polymer film.

Alternatively, at least the first dielectric layer, preferably both, may be coated with an anti-fouling layer to assist in the establishing the desired microdroplet/carrier fluid/surface contact angle at the various virtual electrowetting electrode locations. The anti-fouling layer is intended additionally to prevent the contents of the microdroplets adhering to the surface and being diminished as the microdroplet is moved through the chip. For optimum performance, the anti-fouling layer should assist in establishing a microdroplet/carrier fluid/surface contact angle that should be in the range 50° to 180° when measured as an air-liquid-surface three-point interface at 25° C. In some embodiments, these layer(s) have a thickness of less than 10 nm and are typically formed as a monomolecular layer.

In some embodiments, the microfluidic space includes one or more spacers for holding the first and second walls apart by a predetermined amount. Options for spacers include beads or pillars, ridges created from an intermediate resist layer which has been produced by photo-patterning. Alternatively, deposited material such as silicon oxide or silicon nitride may be used to create the spacers. Alternatively layers of film, including flexible plastic films with or without an adhesive coating, can be used to form a spacer layer. Various spacer geometries can be used to form narrow channels, tapered channels or partially enclosed channels which are defined by lines of pillars. By careful design, it is possible to use these spacers to aid in the deformation of the microdroplets, subsequently perform microdroplet splitting and effect operations on the deformed microdroplets. Similarly these spacers can be used to physically separate zones of the chip to prevent cross-contamination between droplet populations, and to promote the flow of droplets in the correct direction when loading the chip under hydraulic pressure.

Referring to FIG. 1B, there is provided an alternative oEWOD device 100. As shown in FIG. 1B, the oEWOD device comprises: a first composite wall 102 comprised of a first substrate 104, which can be made out of glass, a first conductor layer 106 on the substrate 104, the first conductor layer 106 having a thickness in the range 70 to 250 nm; a photoactive layer 108 activated by electromagnetic radiation in the wavelength range 400 to 850 nm on the conductor layer 106, the photoactive layer 108 having a thickness in the range 300 to 1500 nm and a first dielectric layer 110 on the photoactive layer 108. The first dielectric layer 110 is formed as a continuous layer that has a thickness of less than 20 nm.

The device 100 as shown in FIG. 1B also comprises a second composite wall 112 comprising: a second substrate 114, which can be made out of glass and a second conductor layer 116 on the substrate 114. The second conductor can be transparent. The second conductor layer 116 may have a thickness in the range 70 to 250 nm. A second dielectric layer 118 may be on the second conductor layer 116, where the second dielectric layer 118 has a thickness of less than 20 nm. As with the first dielectric layer, the second dielectric layer must be continuous and the practical lower bound for the thickness is dictated by manufacturing constraints although it could be between 1 nm to 20 nm. The exposed surfaces of the first 110 and second 118 continuous dielectric layers are disposed 20 to 180 μm apart to define a microfluidic space 121 adapted to contain microdroplets 122.

FIG. 1B shows an alternative embodiment of an oEWOD device 100, in which the spacer layer is not formed from a separate material, but is formed as part of a structure within the first (active) substrate 104. The sub layers of the oEWOD device formed from the first conductor layer 106, the photoactive layer 108, the first dielectric layer 110, interstitial binding layer 124 and hydrophobic layer 126 may partially or completely cover the walls of the spacer structure. A further embodiment is an alternative configuration of the device 100, in which the spacer layer is formed by structuring of the second (passive) substrate 114. In some cases, the spacer may be formed by structuring both the first and/or second substrates 104, 114, or by using a combination of structures in the first and/or second substrates 104, 114 and an interposing material such as the channel walls 120, as illustrated in FIG. 1A.

An incident light 130, as illustrated in FIG. 1B, can be used to provide a light sprite pattern 131 in which the incident light 130 illuminates a portion of the photoactive layer 108 to hold the microdroplet 122 into a stationary position within the microfluidic space 121. An oil carrier phase 134 can be provided to the microdroplets 122, through a hole 136 in the device, to replenish key nutrients and components to keep the contents within the microdroplet 122, such as one or more cells, alive and healthy. In some cases, the oil phase 134 can provide key nutrients, medium, media and contents for cell growth, viability and/or productivity.

Referring to FIG. 1C, there is provided a microfluidic device 100 such as an oEWOD or EWOD device 100. The device 100 comprises a first composite wall 102 and a second composite wall 112. The first 102 and second composite walls 112 each comprise a substrate 104, 114, a dielectric layer 110, 118 and a conductor layer 106, 116 made out of ITO. The first composite wall 102 also comprises a photoactive layer 108 and a port 136 extending through the first composite wall 102. One or more microdroplets 122 can enter the microfluidic device 100 through the port 136. A voltage can be applied directly across the one or more aqueous microdroplets 122 as it travels through the port 136.

The device 100 further comprising a hydrophobic layer 126 provided on an interstitial binding layer 124 within the first composite wall 102, as shown in FIG. 1C. An additional interstitial layer 107 is provided between the conductor layer 106 and the photoactive layer 108 within the first composite wall 102. The interstitial binding layers 107, 124 are optional and the channel walls 120 can be made of SU8, or it may be part of the glass structure. A further interstitial layer 124 is provided on the second composite wall 112 between the dielectric layer 118 and the hydrophobic layer 126. The interstitial layer 107, 124 can be a zinc oxide, or a silicon oxide layer.

An incident light 130, as illustrated in FIG. 1C, can be used to provide a light sprite pattern 131 in which the incident light 130 illuminates a portion of the photoactive layer 108 to hold the microdroplet 122 into a stationary position within the microfluidic space 121. An oil carrier phase 134 can be provided to the microdroplets 122, through the hole 136 of the device 100.

Referring to FIGS. 2 and 3, there is provided a microfluidic device 100 such as an oEWOD or EWOD device 100. The device 100 comprises a composite wall 102 known in the art and a second composite wall 112. The first 102 and second composite walls 112 each comprise a substrate 104, 114, a dielectric layer 110, 118 and a conductor layer 106, 116 made out of ITO. The first composite wall 102 also comprises a photoactive layer 108 and a port 136 extending through the first composite wall 102. One or more microdroplets 122 can enter the microfluidic device 100 through the port 136. As shown in FIGS. 2 and 3, the ITO layer 106 of the first composite wall 102 is exposed to the port 136. A voltage is applied directly across the one or more aqueous microdroplets 122 as it travels through the port 136. This may drive electrolysis in the aqueous microdroplet which can damage or even destroy the biomolecules and cells contained therein, and drive the formation of damaging gas bubbles 133. Furthermore, emulsion disruption such as electrolysis and coalescence can be caused by the voltage carried on the exposed conductor layer.

Referring to FIG. 4, there is provided a composite wall 102 according to the present invention for a microfluidic device 100 such as an oEWOD or EWOD device 100. The composite wall 102 comprises a substrate 104, a dielectric layer 110 and a conductor layer 106. The substrate 104 can be fused silica, silicon, silicon dioxide or glass. The conductor layer 106 is provided on the substrate 104 and the dielectric layer 110 is provided on the conductor layer 106. In addition, the composite wall 102 comprises a port 136 extending through the composite wall 102. The composite wall 102 also comprises an insulator which is configured to separate a microdroplet from the conductor layer 106 as the microdroplet passes through the port 136.

The conductive layer 106 can be made from an ITO layer. The conductor layer may be connected to a voltage source such as an A/C voltage source (not shown in the accompanying drawings). The connection ensures that a voltage, typically in the range of 1 V to 100 V, can be applied across the composite wall. Preferably, the voltage applied is in the range of 1 to 7 V.

It is necessary to be able to load droplets through the port of the composite wall under a voltage because this voltage is used to retain other droplets that have already been placed into the microfluidic space in position. However, if there is a voltage applied to the conductive ITO layer, then as the droplets enter the port and passes by the exposed edge of the ITO layer, the droplets are likely to get trapped or merge with each other. Therefore, an insulator is provided to prevent the microdroplet from contacting the conductor layer as the microdroplet passes through the port.

A gap or a recess 138 in the conductor layer 106 is provided as illustrated in FIG. 4, where the conductor layer 106 has been etched away from the vicinity of the port 136 at a pre-determined distance using various etching methods including, but not limited to, laser drilling, diamond drilling, sandblasting and/or wet etching. The etching of the conductor layer 106 away from the port 136 leaves a gap 138 between the port 136 and the conductor layer 106. This ensures that there is no contact between the droplet 122 and the conductor layer 106 as the droplet passes through the port 136 under voltage. This can reduce or eliminate the effects of electrolysis and/or electro-coalescence of the microdroplets and thus, the cells and/or biomolecules contained within the microdroplets remain undamaged. Moreover, the gap 138 between the conductor layer 106 and the port 136 can further minimise or eliminate droplets 122 getting trapped at the port and/or droplets merging with each other. The gap 138 can be filled with a fluid such as oil.

The dielectric layer 110 may be composed of a single dielectric material or it may be a composite of two or more dielectric materials. For example, the dielectric layer may be made from, but is not limited to, a single material such as Al₂O₃ or SiO₂. In another example, the dielectric layer can be made from, but is not limited to, two or more materials such as Al₂O₃ and SiO₂.

The composite wall 102 further comprises a photoactive layer 108. The photoactive layer 108 may be made of amorphous silicon. The photoactive layer 108 may be activated by electromagnetic radiation in the wavelength range of 400to 1000 nm on the conductor layer. The first dielectric layer may be deposited onto the photoactive layer by atomic layer deposition. Additionally or alternatively, the second dielectric layer may be deposited onto the photoactive layer.

Alternatively or additionally, the insulator can be the photoactive layer 108. The photoactive layer 108 can encapsulate the conductor layer 106 at the port 136 to ensure that the conductor layer 106 does not contact the microdroplet 122 as it passes through the port 136.

Under control from an applied voltage, the microdroplets 122 enter through the port 136 and into the microfluidic workspace 121 where they can then be manipulated by EWOD or oEWOD forces. The port 136 may have a sufficient diameter to allow one or more microdroplets 122 to enter into the microfluidic device 100. The microdroplets 122 can travel through the composite wall 102 in a sequential manner. Alternatively, two or more microdroplets 122 may enter through the port 136 and into the device 100 at the same time. The port 136 may have a uniform diameter in length and/or width. Alternatively, the port 136 may have a tapered region.

The port 136 through the composite wall 102 can be formed by laser drilling through the layers of the composite wall 102. Other techniques that can be used to create a port through the composite wall may include, but is not limited to, diamond drilling, sandblasting and wet etching. It is known by the skilled person in the art that alternative techniques can be used to form a port through the composite wall.

FIG. 4 also shows a second composite wall 112 comprising a substrate 114, a conductor layer 116 provided on the substrate, a dielectric layer 118 provided on the conductor layer 116. The two composite walls 102, 112 can be separated by a microfluidic gap or space 121 of between 20 to 120 microns. In some instances, the gap 121 between the two composite walls 102, 112 may be more than 20, 30, 40, 50, 60, 70, 80, 90, 100 or 110 microns. In some instances, the gap between the two composite walls may be less than 120, 110, 100, 90, 80, 70, 60, 50, 40 or 30 microns.

The two composite walls 102, 112 may be part of a EWOD or an oEWOD device 100. The oEWOD device may further comprise an A/C source to provide a voltage across the first and second composite walls connecting the first and second conductor layers; at least one source of electromagnetic radiation having an energy higher than the bandgap of the photoexcitable layer adapted to impinge on the photoactive layer to induce corresponding ephemeral electrowetting locations on the surface of the first dielectric layer; and a microprocessor for manipulating the points of impingement of the electromagnetic radiation on the photoactive layer so as to vary the disposition of the ephemeral electrowetting locations thereby creating at least one electrowetting pathway along which the microdroplet may be caused to move.

The A/C source (not shown in the accompanying drawings) is configured to provide a voltage of between 1V and 100V across the first and second composite walls connecting the first and second conductor layers.

The conductor layer on the substrate may be a thickness in the range 70 to 250 nm. The photoactive layer may be activated by electromagnetic radiation in the wavelength range 400 to 1000 nm on the conductor layer.

The source of electromagnetic radiation may be an LED light source or other lamps, which may provide electromagnetic radiation at a level of 0.005 to 0.1 Wcm⁻². In some instances, the source of electromagnetic radiation is at a level of 0.005 to 0.1 Wcm⁻², or it could be more than 0.005, 0.0075, 0.01, 0.025, 0.05 or 0.075 Wcm⁻². In some embodiments, the source of electromagnetic radiation is at a level may be less than 0.1, 0.075, 0.05, 0.025, 0.01, 0.0075, 0.005 or 0.0025 Wcm⁻².

This enables highly complex patterns of virtual electrowetting electrode locations to be rapidly created and destroyed on the first dielectric layer thereby enabling the microdroplets to be precisely steered along essentially any virtual pathway using closely-controlled electrowetting forces. Such electrowetting pathways can be viewed as being constructed from a continuum of virtual electrowetting electrode locations upon the first dielectric layer.

In some embodiments, the second composite wall may further comprise a second photoexcitable layer and the source of electromagnetic radiation may also impinge on the second photoexcitable layer to create a second pattern of ephemeral electrowetting locations which can also be varied. The source of electromagnetic radiation may be an LED light source, which may provide electromagnetic radiation at a level of 0.005 to 0.1 Wcm⁻².

A structure may be provided between the first and second dielectric layers. The structure between the first and second dielectric layers can be made of, but is not limited to, epoxy, polymer, silicon or glass, or mixtures or composites thereof, with straight, angled, curved or micro-structured walls/faces. The structure between the first and second dielectric layers may be connected to the first and second composite walls to create a sealed microfluidic device and define the channels and regions within the device. The structure may occupy the gap between the two composite walls. Alternatively, or additionally, the conductor and dielectrics layers may be deposited on a shaped substrate that already has walls.

The device according to FIGS. 4 to 13 may optionally be provided with a spacer structure which is not shown in FIGS. 4 to 13. The spacer structure, if provided, is positioned between the first and second composite walls 102, 112 of the device 100. Additionally or alternatively, the device according to FIGS. 4 to 13 may also comprise anti-fouling layers and/or the interstitial layers which are, likewise, not shown in FIGS. 4 to 13.

The microdroplet may contain a biological and/or chemical entity such as a biomolecule. The biomolecule may be, but is not limited to, a nucleic acid such as DNA, RNA or mRNA, a protein, a peptide or polypeptide, an enzyme, polysaccachrides, a peptide, a protein, an antibody and/or antibody fragment thereof. The microdroplet may also comprise other ingredients such as buffers, vitamins, minerals, nutrients, gases such as oxygen and/or co-factors. The microdroplet may contain one or more cells.

Referring to FIGS. 5, there is provided an alternative structure of the composite wall 102 according to the present invention. As shown in FIGS. 5 and 6A, there is provided a first composite wall 102 comprising a substrate 104, a dielectric layer 110 and a conductor layer 106 made out of ITO. The first composite wall 102 also comprises a photoactive layer 108.

FIGS. 5 and 6A also shows a second composite wall 112 comprising a substrate 114, a conductor layer 116 provided on the substrate 112, a dielectric layer 118 provided on the conductor layer 116. The two composite walls 102, 112 can be separated by a microfluidic space or gap 121 of between 20 to 120 microns. FIG. 5 illustrates that a port 136 is provided on the second composite wall 114. The port 136 can extend through the second composite wall 112 to allow microdroplets 122 to be loaded into the microfluidic device 100 under voltage.

As shown in FIG. 5, the etching of the second conductor layer 116 away from the port 136 leaves a gap 138 between the port 136 and the conductor layer 116 on the second composite wall 112. This ensures that there is no contact between the droplet 122 and the conductor layer 116 as the droplet passes through the port 136 under voltage.

Alternatively or additionally, the insulator is a continuous dielectric layer 110 that encapsulates at least the conductor layer 106 around the vicinity of the port 136, as shown in FIG. 6A. The encapsulation of the conductor layer 106 around the vicinity of the port 136 ensures that the conductor layer 106 does not contact the microdroplet 122 as it passes through the port 136. In some instances, the dielectric layer 110 that encapsulates the conductor layer 106 at the port 136 may have at least the same breakdown voltage as the dielectric layer 110 of the composite wall 102.

In circumstances where a pinhole defect is encountered in the dielectric layer 110 that forms the insulator, or the dielectric layer 110 that is part of the composite wall 102, it can be advantageous that the dielectric layer 110 of the composite wall 102 provides equal dielectric strength to the dielectric layer 110 that forms the insulator, and vice versa. The dielectric strength must be at least high enough around the vicinity of the port 136 to prevent breakdown under the same conditions where the oEWOD device 100 is holding the microdroplets 122. As shown in FIG. 6A, the dielectric layer 110 that forms the insulator may also encapsulate the photoactive layer 108 and a portion of the substrate 104 around the vicinity of the port 136. This alternative arrangement ensures that the conductor layer 106 does not contact the microdroplets 122 as it passes through the port 136.

As shown in FIG. 6B, there is shown an alternative device 100 to the one illustrated in FIG. 6A. In FIG. 6B, a hydrophobic layer 126 is provided on the first composite wall 102. The dielectric layer 110 lines the port 136 to provide the insulator. In addition, the hydrophobic layer 126 can be provided on the surface of the insulator around the vicinity of the port 136, as illustrated in FIG. 6B. The presence of a hydrophobic layer 126 in the vicinity of the port 136 can reduce the size of the contact patch between the droplets 122 of the emulsion and the inner layer of the port 136, in which the inner layer of the port 136 comprises at least the conductor layer 106. Additionally or alternatively, the hydrophobic layer 126 provided around the vicinity of the port 136 may also prevent the wetting of the droplets 122 on to the wall 102.

Referring to FIG. 6C, there is provided an alternative device 100 to the one illustrated in FIGS. 6A and 6B. In FIG. 6C, at least a portion of the conductor layer 106, the photoactive layer 108, the dielectric layer 110 and the hydrophobic layer 126 lines the port 136 to provide the insulator. As shown in FIG. 6C, the conductor layer 106 is adjacent to the substrate 104 of the first composite wall 102. The photoactive layer 108, the dielectric layer 110 and the hydrophobic layer 126 is then provided to encapsulate the conductor layer 106 that lines the inner part of the port 136. This alternative arrangement ensures that the conductor layer 106 does not contact the microdroplets 122 as it passes through the port 136.

Referring to FIG. 7, there is shown a composite wall 102 comprising a substrate 104, a dielectric layer 110 and a conductor layer 106. The composite wall 102 comprises a photoactive layer 108 which can be made from amorphous silicon.

FIG. 7 also shows a second composite wall 112 comprising a substrate 114, a conductor 116 layer provided on the substrate 112, a dielectric layer 118 provided on the conductor layer 116. As shown in FIG. 6, the dielectric layer 118 forms the insulator and encapsulates the conductor layer 116 at the port 136. The two composite walls 102, 112 can be separated by a microfluidic space or gap 121 of between 20 to 120 microns.

FIG. 7 illustrates an embodiment in which the port 136 is provided at an acute angle a, relative to the second composite wall 112, through which a microdroplet 122 passes through it. When the microdroplet 122 passing through the angled port 136, the stresses on the microdroplet differ from those experienced in a perpendicular port resulting in a lower shear stress as the microdroplet transitions from the angled port 136 into the microfluidic space 121. By reducing the shear stress, the biological entity, such as a cell, held within the microdroplet is likely to have an improved viability in comparison with a higher shear stress transition.

Furthermore, by providing an angled port 136, the microdroplets can be guided into the microfluidic space 121 in a particular direction. This may be useful in reducing electrolysis or electro-coalescence of the microdroplets and thus, less power may be required to move microdroplets through the port of the composite wall.

The angle of the port relative to the substrate can be any angle less than 90 degrees. In some cases, the angle of the port relative to the substrate may be less than 85, 80, 75, 70, 65, 60, 55, 50, 45, 40, 35, 30, 25, 20, 15, 10 or 5 degrees. Alternatively, the angle of the port relative to the substrate may be more than 5, 10, 15, 20, 25, 30, 35, 40, 45, 50, 55, 60, 65, 70, 75, 80 or 85 degrees.

Referring to FIGS. 8A to 8C, there is provided a composite wall 102 comprising a substrate 104, dielectric layers 110 a photoactive layer 108 of amorphous silicon and a conductive layer 106. The substrate 104 can be fused silica, silicon, silicon dioxide or glass. The composite wall 102 also comprises a first dielectric layer made out of silica 142 and a second dielectric layer made from aluminium oxide 144. The port 136 allows microdroplets to enter into the microfluidic workspace whilst a voltage is applied to enable the microdroplets to be manipulated by oEWOD forces. It is necessary to be able to load microdroplets through the ports of the composite wall whilst a voltage is applied, because this voltage is used to retain other droplets within microfluidic device into position. However, if there is a voltage applied to the conductive ITO layer, then as droplets pass by the exposed edge of the ITO layer, the microdroplets can get trapped or merge with each other.

Referring to FIG. 8B, a protective layer 146 is provided onto top of the layers 147 of the composite wall 102. In particular, the protective layer 146 is provided on top of the dielectric layers 110. The protective layer 146, such as a photomask, can be a photoresist layer or it could be any other suitable patternable layer such as aluminium. The photoresist layer can be spin-or spray-coated onto the surface of the dielectric layers, and patterned by photolithography so that a pre-determined area 148 of the composite layers 147 is left uncovered by the protective layer 146. This pre-determined area 148 i.e. distance away from the port is approximately 0.001 to 2 mm.

Alternatively, after spin or spray-coating of the photoresist layer onto the layers of the composite wall, patterning can take place through lift-off of an underlying masking material such as polyimide tape, to expose areas where the coating layer is to be removed. As such, two areas are created on the surface of the composite wall. The first area on the surface of the composite wall is covered by the protective layer. The second area on the surface of the composite wall is not covered by the protective layer.

Referring to FIG. 8C, the uncovered surfaces 148 of the composite layers 147 are removed down to the substrate 104 by wet or dry etching using reactive fluids, which can be a liquid, gas or plasma. For example, in a first etching step, the dielectric layers 142, 144 are subjected to dry etching by a reactive plasma such as fluoroform for 5 minutes, followed by sulfur hexafluoride plasma for 30 minutes. Then, in a subsequent step, the dielectric layers 142, 144 are subjected to wet etching with 37% hydrogen chloride for 7 minutes. The end result of the etching process is illustrated in FIG. 8C, in which a part of the dielectric layers 142, 144, the photoactive layer 108 and the conductive ITO layer 106 around the vicinity of the port 136 are removed. This creates a recess or a gap in the uncovered surface 48, which comprise of dielectric layers 42, 44, photoactive layer 108 and the conductor layer 106. Thus, when in use, the microdroplets can be loaded into the port 136 whilst a voltage is applied across the device without interacting with the conductive ITO layer.

Referring to FIG. 9A, there is shown a composite wall 102 comprising a substrate 104, a photoactive layer 108, a conductor layer 106 and dielectric layers 110. FIGS. 9A to 9B provides an illustration of an alternative etching process of the layers of the composite wall. As shown in FIG. 9A and 9B, the conductor layer 106 is etched away from the vicinity of the port 136 to create a recess 150 in the conductor layer 106. The recess 150 can be filled with a fluid such as oil.

During the etching process, a portion of the composite wall 102 is immersed in a protective liquid. A protective layer (not shown in FIG. 9) is formed on the immersed layers of the composite wall 102. The protective liquid can be of any suitable liquid in which the etchant is insoluble. HFE-7500 can be used with a hydrogen chloride gas etchant because HFE-7500 is insoluble to hydrogen chloride and therefore forms a protective layer on the immersed layers of the composite wall.

The partially immersed composite wall 102 can be etched in a hydrogen chloride gas atmosphere. As illustrated in FIG. 9B, the layers that are not protected by the protective layer of HFE-7500, i.e. the un-immersed layers of the conductive ITO 106 and aluminium oxide layers 144, are the exposed. The un-immersed layers are etched to create a gap 150 in the ITO layer 106 and a gap 151 in the aluminium oxide layer 144 near the port 136. As an example, the partially submerged composite wall can be exposed to an etching hydrogen chloride gas atmosphere for 5 hours, resulting in an etching of the exposed ITO and aluminium oxide layers, a distance of 8-12 μm into the layers, underneath the silica layer and/or the amorphous silicon layer.

The composite wall can then be cleaned by sonication in water to remove the residual hydrogen chloride from the composite wall. This prevents further undesired etching of the conductive ITO and aluminium oxide layers when they are no longer immersed in the HFE-7500 protective liquid.

FIG. 9B illustrates the structure of the composite wall 102 after etching, which shows the conductive ITO 106 and aluminium oxide 144 layers etched under the silica 142 and amorphous silicon 108 layers around the vicinity of the port 136.

Referring to FIGS. 10A to 10E, there is shown a composite wall 102 comprising a substrate 104, a photoactive layer 108, a conductor layer 106 and dielectric layers 110. FIGS. 10A to 10E provide an illustration of an alternative etching process of the layers of the composite wall 102. As shown in FIGS. 9A to 9E, at least a portion of the conductive ITO layer 106 is removed from the surface of the composite wall 102. The removal of the ITO layer 106 is carried out prior to the deposition of further layers 52 on the conductive ITO layer 106 and prior to the drilling of the port 136 through the composite wall 102.

As illustrated in FIG. 10A, the entire surface of the substrate 104 can be coated with a conductive layer of ITO 106. A protective layer 146 can be deposited on top of the conductive layer 106 in order to protect areas of the conductive layer 154, which are not to be etched, as shown in FIG. 10B. The protective layer 146 can be a photoresist layer or it can be any other suitable patternable layer such as aluminium.

The protective layer 146 can be deposited on top of the conductive layer 106 by spin or spray-coating, and can be patterned using photolithography. This creates a first area 154 of the surface of the composite wall, which is covered by the protective layer 146, whilst a second area 156 of the surface of the composite wall 102 is not covered by the protective layer 146. The second area 156 of the composite wall 102 comprises an exposed ITO layer 106 to be removed. As illustrated in FIG. 9B, the exposed ITO layer 106 is not covered by the protective layer 146.

A fluid capable of reacting with the conductor layer, which can be hydrogen chloride liquid, solution or gas, or oxalic acid solution, can be applied to the entire surface of the composite wall. This causes the exposed conductor layer 106 to be etched down to the substrate 104, as shown in FIG. 10C. For example, the entire substrate can be immersed in 37% hydrogen chloride for 7 minutes. Alternatively, a plasma capable of reacting with the conductor layer can be applied to the entire surface of the wall. The plasma can be, but is not limited to, a methane and hydrogen plasma, chlorine and argon plasma, or carbon tetrafluoride plasma.

Alternatively or additionally, the exposed conductor layer can be removed from the surface of the substrate using laser ablation.

After treatment with a reactive fluid or laser, the surface of the composite wall can be cleaned by sonication in water to remove any residual hydrogen chloride from the surface of the device, and prevent any further undesired etching of the conductor layer once the protective layer is removed. The protective layer can be removed from the surface of the device by solvent cleaning and oxygen plasma cleaning.

As shown in FIG. 10D, further layers 152 are deposited onto the entire surface of the composite wall 102 by physical vapour deposition, atomic layer deposition, chemical vapour deposition and/or evaporation. The further layers 152 include a photoactive layer 108 of amorphous silicon, a first dielectric layer of silicon oxide 142 and a second dielectric layer of aluminium oxide 144.

In a subsequent step as shown in FIG. 10E, a port 136 is created within the composite wall 102 by drilling through the composite wall 102 at a location where the conductive ITO layer 106 has been removed. One or more microdroplets can then be loaded into the device through the port under voltage. Importantly, the microdroplets do not interact with the conductive ITO layer.

In an alternative embodiment, the conductive ITO layer can be removed from the substrate through laser ablation. In this embodiment, the entire surface of the substrate is coated with a conductive ITO layer, as shown in FIG. 10A. Optionally, a protective layer can be deposited on top of the conductive layer in order to protect areas of the conductive layer, which are not to be etched, as shown in FIG. 10B.

Subsequently, laser ablation can be used to remove a part of the conductive ITO layer on the surface of the substrate. As a result, a first area 154 on the surface of the substrate 104 is covered with the conductive ITO layer 106 and a second area 156 is not covered with the conductive ITO layer, as shown in FIG. 10C.

Further layers 152 can be deposited onto the entire surface of the substrate using various deposition techniques such as physical vapour deposition, atomic layer deposition, chemical vapour deposition and/or evaporation. As shown in FIG. 10D, the further layers 152 comprise a photoactive layer 108 of amorphous silicon, a first dielectric layer made out of silicon oxide 142, and a second a second dielectric layer made out of aluminium oxide 144.

In a subsequent step as shown in FIG. 10E, a port 136 is created within the composite wall 102 by drilling through the composite wall 102 at a location where the conductor layer 106 has been removed.

Alternatively, the step of drilling through the composite wall can be carried out prior to depositing the further layers onto the substrate. Microdroplets can be loaded into the device through the port without contacting the ITO layer.

Referring to FIGS. 11A to 11B, there is shown a port 136 located on the side of the device 100. The device 100 comprises a first composite wall 102 and a second composite wall 112. The first composite wall 102 comprises at least a substrate 104, a dielectric layer 110 and a conductor layer 106. A photoactive layer 108 is also provided within the first composite wall 102. The second composite wall 112 comprises a substrate 114, a dielectric layer 118 and a conductor layer 116. The microdroplets are loaded into the microfluidic space 121 through the port 136 located at the side of the device 100, as illustrated in FIG. 11B. As illustrated in FIG. 11A, when the microdroplets are loaded into the device 100 through the port 136, at least the conductor layer 106 of the composite wall 102 around the vicinity of the port 136 is etched 155, according to any one of the etching method(s) described herein. This helps prevent the microdroplets coming into contact with the conductor layer 106 at the side of the device 100. The microdroplets passing through the port enters the device area 157, as indicated in FIG. 11A.

As part of the etching process, a protective layer is deposited onto most of the layers 104, 110, 106 of the composite wall 102 and/or the side port 136. The protective layer can be a photomask such as a photoresist layer or it can be any other suitable patternable layer such as aluminium.

In some instances, the protective layer can be made of a single layer or the protective layer can be made of multi layers. A photoresist layer can be spin or spray-coated onto the surface of the composite wall, and patterned by photolithography so that an area of the composite wall, typically near the port, is left uncovered by the protective layer.

Alternatively, after spin-or spray-coating the photoresist, patterning can take place through lift-off of an underlying masking material such as polyimide tape, to expose areas where the layers of the composite wall are to be removed. As such two areas are created; a first area on the surface of the composite wall is covered by the protective layer and a second area that is not covered by the protective layer. The uncovered layers are removed down to the substrate by wet or dry etching using reactive fluids, which can be a liquid, gas or plasma. This is illustrated in FIG. 11B which shows the dielectric layers 142, 144, photoactive layer 108 and the conductor layer 106 being etched away from the port 136 at a distance of between 0.001 to 2 mm. In addition, the silicon oxide 142 and the aluminium oxide 144 that form the second dielectric layer 118, and conductor layer 116 of the second composite wall 112 respectively are also etched away from the port 136, as shown in FIG. 11B.

Referring to FIG. 12A to 12B, there is shown a device 100 comprising a composite wall 102. The composite wall 102 comprises at least a substrate 104, a dielectric layer 110 and a conductor layer 106. The conductor layer 106 can be made out of ITO. A photoactive layer 108 is also provided within the first composite wall 102. A second composite wall 112 is provided as shown in FIG. 12B. The second composite wall 112 comprises a substrate 114, a dielectric layer 118 and a conductor layer 116. As shown in FIGS. 12A and 12B, a port 136 can be located at the side of the device 100. A portion of the composite wall 102 i.e. at least the conductor layer is etched 155 away from the port 136, as illustrated in FIG. 12A. Microdroplets are then loaded into the microfluidic area 157, as shown in FIG. 12A, through the cavity in the side of the device 100.

As illustrated in FIG. 12B, a part of the conductor layer 106, 116 of the composite wall 102, 112 is etched or removed to provide a recess 150 in the conductor layer 106, 116. This helps prevent the microdroplets coming into contact with the conductor layer 106 at the side of the device 100. Thus, it prevents the microdroplets becoming trapped and merging during introduction to the device. As shown in FIG. 12B, a part of the aluminium oxide layer 142 is also etched away to provide a recess 151 in the aluminium oxide layer 142.

The composite wall 102 is immersed into a protective liquid such as HFE-7500. This forms a protective layer on the most of the surface of the composite wall.

However, there is a part of the surface near the port which does not have a protective layer and thus, this surface is exposed. The entire surface of the device can then be exposed to a hydrogen chloride gas atmosphere. The exposure of the composite wall to hydrogen chloride gas atmosphere causes the etching of the exposed conductive ITO 106 and the aluminium oxide layer 144 around the vicinity of the port 136, as shown in FIG. 12B. Subsequent cleaning of the device can remove residual hydrogen chloride and prevent further undesired etching, once the device is removed from the protective liquid.

Referring to FIGS. 13A to 13B, there is shown a device 100 comprising a composite wall 102. The composite wall 102 comprises at least a substrate 104, a dielectric layer 110 and a conductor layer 106. The conductor layer 106 can be made out of ITO. A photoactive layer 108 is also provided within the first composite wall 102. A second composite wall 112 is provided as shown in FIG. 13B. The second composite wall 112 comprises a substrate 114, a dielectric layer 118 and a conductor layer 116. As shown in FIGS. 13A and 13B, a port 136 is provided on the side of the device 100. An area of the composite wall can be etched or removed 155 by laser ablation to prevent the microdroplets coming into contact with the ITO layer 106 as it passes through the port 136. This enables the microdroplets to be loaded into the device area 157 from the side under voltage, whilst preventing the droplets merging together or getting trapped at the port.

As shown in FIG. 13B, a conductor layer 106 is deposited onto the substrate 104 of the composite wall 102. A protective layer is then deposited onto the conductor layer 106 to cover a portion of the conductor layer 106. The protective layer can be deposited by spin or spray-coating and can be patterned using photolithography. As a result, a first area on the substrate is covered by the protective layer and a second area on the substrate is not protected by the protective layer. The unprotected area of the substrate 104 comprises an exposed ITO layer 106.

The exposed ITO layer can be removed by etching with a reactive fluid or by laser ablation. In a subsequent step, the surface of the composite wall can be cleaned by sonication in water, by solvent cleaning and by oxygen plasma cleaning. Alternatively, the exposed ITO layer can be removed from the substrate through laser ablation.

Further layers 152 including, but not limited to, a dielectric layer 110 made out of silicon oxide 142, a dielectric layer 110 made out of aluminium oxide 144 and a photoactive layer 108 are deposited onto the entire surface of the composite wall 102. Further layers can be deposited onto the substrate using various deposition techniques such as physical vapour deposition, atomic layer deposition, chemical vapour deposition and/or evaporation. Other deposition techniques may also be used. In a subsequent step, a port 136 is then created by drilling through the side of the device 102 at a location where the ITO layer 106 has been etched or removed, as shown in FIG. 13B.

Alternatively, the step of drilling through the composite wall can be carried out prior to depositing the further layers onto the substrate. Microdroplets can be loaded into the device through the port without contacting the ITO layer.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1.-29. (canceled)

30. A composite wall for an oEWOD or EWOD device, the wall comprising:
a substrate;
a conductor layer provided on the substrate;
a dielectric layer provided on the conductor layer; and
a port extending through the composite wall; and
an insulator configured to separate a microdroplet from the conductor layer as the microdroplet passes through the port.

31. The composite wall according to claim 30, wherein the insulator is provided by a recess formed in at least a portion of the conductor layer.

32. The composite wall according to claim 30, wherein the dielectric layer lines the port to provide the insulator.

33. The composite wall according to claim 30, wherein the port has a constant diameter.

34. The composite wall according to claim 30, wherein the substrate defines a plane and the port extends through the composite wall in a direction substantially perpendicular to the plane.

35. The composite wall according to claim 30, wherein the port is provided at an acute angle relative to the composite wall.

36. The composite wall according to claim 30, further comprising a photoactive layer provided between the conductor layer and the dielectric layer.

37. The composite wall according to claim 36, wherein the photoactive layer lines the port to provide the insulator.

38. The composite wall according to claim 36, wherein the photoactive layer and the dielectric layer line the port to provide the insulator.

39. The composite wall according to claim 32, wherein the dielectric layer that lines the port to provide the insulator encapsulates at least the conductor layer around the vicinity of the port, wherein the dielectric layer that encapsulates at least the conductor layer has the same breakdown voltage as the dielectric layer of the composite wall.

40. The composite wall according to claim 31, wherein the conductor layer recesses away from the vicinity of the port by at least 0.001 mm.

41. The composite wall according to claim 31, wherein the conductor layer recesses away from the vicinity of the port by at least 0.01 mm.

42. The composite wall according to claim 31, wherein the conductor layer recesses away from the vicinity of the port by at least 0.1 mm.

43. The composite wall according to claim 30, wherein the port is substantially circular.

44. The composite wall according to claim 30, wherein the port is substantially square shaped.

45. The composite wall according to claim 30, wherein the wall further comprises a hydrophobic layer.

46. A composite wall for an oEWOD or EWOD device, the wall comprising:
a substrate;
a conductor layer provided on the substrate;
a dielectric layer provided on the conductor layer; and
a port extending through the composite wall for allowing a microdroplet to pass therethrough;
wherein the port is configured to insulate the microdroplet from the conductor layer.

47. An oEWOD or EWOD device comprising a first composite wall and a second composite wall, one of which is a composite wall according to claim 30.

48. The oEWOD or EWOD device according to claim 47, wherein the second composite wall comprises:
a substrate;
a conductor layer provided on the substrate; and
a dielectric layer provided on the conductor layer.

49. The oEWOD or EWOD device according to claim 47, wherein the two composite walls are separated by a gap of between 20 to 120 microns.
